(19) United States
(12) Patent Application Publication
(10) Pub. No.: US 2016/0253024 A1
(43) Pub. Date: Sep. 1, 2016

(54) DISPLAY PANEL WITH TOUCH DETECTION FUNCTION

(71) Applicants: Panasonic Liquid Crystal Display Co., Ltd., Hyogo (JP); Panasonic Corporation, Osaka (JP)

(72) Inventors: Toshiyuki AOYAMA, Osaka (JP); Tetsuo FUKAMI, Hyogo (JP); Daisuke KAJITA, Hyogo (JP); Kazushige TAKAGI, Osaka (JP)

(21) Appl. No.: 14/681,116

(22) Filed: Apr. 8, 2015

Related U.S. Application Data
(60) Provisional application No. 62/121,516, filed on Feb. 27, 2015.

(51) Int. Cl. G06F 3/041; G06F 3/044

(52) U.S. Cl. CPC G06F 3/0416; G06F 3/044

(57) ABSTRACT

Provided is a display panel including: a plurality of pixel electrodes divided into a plurality of groups; and a plurality of common electrodes arranged at a ratio of one to a plurality of pixel electrodes included in one of the plurality of groups. A plurality of sensor electrode lines are arranged in the same layer as a plurality of data signal lines. The plurality of sensor electrode lines and each of the plurality of common electrodes overlap each other in plan view. The each of the plurality of common electrodes is electrically connected to at least one of the plurality of sensor electrode lines. At least one insulating film is formed between each of a region between the data signal lines and the sensor electrode lines, a region between the sensor electrode lines and the common electrodes, and a region between the common electrodes and the pixel electrodes.

### BACKGROUND

1. Field of the Invention

The present application relates to a display panel with touch detection function.

2. Description of the Related Art

Hitherto, various display devices with touch panels have been proposed. In recent years, in order to reduce the thickness of the entire display device, there has been proposed a so-called in-cell display device with touch detection function, which incorporates a function of a touch panel inside a display panel. The above-mentioned display device is disclosed in, for example, U.S. Pat. No. 8,766,950. Further, in the above-mentioned publication, there is disclosed an in-plane switching (IPS) display panel that is excellent in wide viewing angle characteristics.

### SUMMARY

However, in the technology disclosed in the above-mentioned publication, the following two problems mainly arise. The first problem resides in that the manufacturing process is complicated, and hence the product cost is increased. FIG. 32 is a plan view of a display panel disclosed in the above-mentioned publication. As illustrated in FIG. 32, when a sensor electrode line 706 is formed in a different layer from that of a source line 704, the number of wiring layers is increased. With this, the manufacturing process is complicated, and the product cost is increased. The second problem resides in reduction in detection accuracy of a touch position. As illustrated in FIG. 32, when the sensor electrode line 706 is formed in proximity to the source line 704, the sensor electrode line 706 is susceptible to an electric field from the source line 704. In this case, the detection accuracy of the touch position is remarkably reduced due to the influence of the above-mentioned electric field.

The present application has been made in view of the above-mentioned problems, and has an object to provide a display panel with touch detection function, which is intended to decrease the cost through simplification of the manufacturing process, and excellent in detection accuracy of the touch position.

In order to solve the problems described above, according to one embodiment of the present application, there is provided a display panel, including: a plurality of gate signal lines extending in a first direction; a plurality of data signal lines and a plurality of sensor electrode lines, which extend in a second direction different from the first direction; a plurality of pixel electrodes arranged so as to respectively correspond to a plurality of pixels arrayed in the first direction and the second direction, the plurality of pixel electrodes being divided into a plurality of groups; and a plurality of common electrodes arranged at a ratio of one to a plurality of pixel electrodes included in one of the plurality of groups, in which: the plurality of sensor electrode lines are arranged in the same layer as the plurality of data signal lines; at least two of the plurality of sensor electrode lines and each of the plurality of common electrodes overlap each other in plan view, and the each of the plurality of common electrodes is electrically connected to at least one of the at least two of the plurality of sensor electrode lines overlapping with the each of the plurality of common electrodes; and at least one insulating film is formed between each of a region between the plurality of data signal lines and the plurality of sensor electrode lines, a region between the plurality of sensor electrode lines and the plurality of common electrodes, and a region between the plurality of common electrodes and the plurality of pixel electrodes.

In the display panel according to one embodiment of the present application, each of the plurality of sensor electrode lines may be arranged between adjacent two of the plurality of data signal lines in plan view.

In the display panel according to one embodiment of the present application, each of the plurality of sensor electrode lines may be arranged at a position with a substantially equal distance from each of adjacent two of the plurality of data signal lines in plan view.

In the display panel according to one embodiment of the present application, the plurality of common electrodes may be arrayed at equal intervals in the first direction and the second direction.

In the display panel according to one embodiment of the present application, the each of the plurality of common electrodes may be electrically connected to at least one of the plurality of sensor electrode lines via a through hole formed through the at least one insulating film formed in the region between the plurality of sensor electrode lines and the plurality of common electrodes.

In the display panel according to one embodiment of the present application, the plurality of data signal lines and the plurality of sensor electrode lines may be formed on a first insulating film formed so as to cover the plurality of gate signal lines. A second insulating film may be formed between the plurality of data signal lines and the plurality of sensor electrode lines so as to cover the plurality of data signal lines and the plurality of sensor electrode lines. A third insulating film may be formed on the second insulating film. The plurality of common electrodes may be formed on the third insulating film. A fourth insulating film may be formed between the plurality of common electrodes and the plurality of pixel electrodes so as to cover the plurality of common electrodes. The plurality of pixel electrodes may be formed on the fourth insulating film. The second insulating film and the third insulating film may each have a through hole formed in a part thereof so as to electrically connect the each of the plurality of sensor electrode lines and corresponding one of the plurality of common electrodes to each other.

In the display panel according to one embodiment of the present application, the plurality of pixels may include a red pixel for displaying red, a green pixel for displaying green, and a blue pixel for displaying blue, and each of the plurality of sensor electrode lines may be arranged in the red pixel and the blue pixel, but may not be arranged in the green pixel.

In the display panel according to one embodiment of the present application, the plurality of data signal lines, the plurality of the sensor electrode lines, and the plurality of pixel electrodes may be formed on a first insulating film formed so as to cover the plurality of gate signal lines. A second insulating film may be formed between the plurality of data signal lines and the plurality of sensor electrode lines so as to cover the plurality of data signal lines, the plurality of the sensor electrode lines, and the plurality of pixel electrodes. The plurality of common electrodes maybe formed on the second insulating film. The second insulating film may have a through hole formed in a part thereof so as to electrically connect the each of the plurality of sensor electrode lines and corresponding one of the plurality of common electrodes to each other.

In the display panel according to one embodiment of the present application, the at least one insulating film may be made of an organic material.

In the display panel according to one embodiment of the present application, shielding wiring may be arranged so as to cover a gap between adjacent two of the plurality of common electrodes in plan view.

In the display panel according to one embodiment of the present application, the plurality of common electrodes may be arranged so that a gap between adjacent two of the plurality of common electrodes overlaps with a gap between adjacent pixels in plan view.

In the display panel according to one embodiment of the present application, the plurality of common electrodes may be arranged so that a gap between adjacent two of the plurality of common electrodes is positioned close to a center of a pixel region in plan view.

In the display panel according to one embodiment of the present application, a number of the sensor electrode lines to be electrically connected to corresponding one of the plurality of common electrodes, which is arranged on a side closer to a first drive circuit for outputting a sensor voltage, may be smaller than a number of the sensor electrode lines to be electrically connected to corresponding one of the plurality of common electrodes, which is arranged on a side farther from the first drive circuit.

### BRIEF DESCRIPTION OF THE DRAWINGS

FIG. 1 is a plan view illustrating a schematic configuration of a liquid crystal display device according to an embodiment of the present application.

FIG. 2 is a plan view illustrating details of a display panel of a first embodiment.

FIG. 3 is a block diagram illustrating a configuration of a common/sensor driver.

FIG. 4 is an A-A′ sectional view of the display panel of the first embodiment.

FIG. 5 is a plan view illustrating details of a display panel of a second embodiment.

FIG. 6 is a B-B′ sectional view of a display panel of a second embodiment.

FIG. 7 is a sectional view illustrating another configuration of the display panel of the second embodiment.

FIG. 8 is a sectional view illustrating another configuration of the display panel of the second embodiment.

FIG. 9 is a plan view illustrating a configuration of common electrodes of a display panel of each of third and fourth embodiments.

FIG. 10 is a C-C′ sectional view of the display panel of the third embodiment.

FIG. 11 is a sectional view illustrating another configuration of the display panel of the third embodiment.

FIG. 12 is a D-D′ sectional view of the display panel of the fourth embodiment.

FIG. 13 is an A-A′ sectional view of a display panel of a fifth embodiment.

FIG. 14 is a B-B′ sectional view of a display panel of a sixth embodiment.

FIG. 15 is a C-C′ sectional view of a display panel of a seventh embodiment.

FIG. 16 is a D-D′ sectional view of a display panel of an eighth embodiment.

FIG. 17 is a plan view illustrating a configuration common to a display panel of each of ninth and tenth embodiments.

FIG. 18 is a plan view illustrating a configuration common to a display panel of each of eleventh and twelfth embodiments.

FIG. 19 is an A-A′ sectional view of the display panel of the ninth embodiment.

FIG. 20 is a B-B′ sectional view of the display panel of the tenth embodiment.

FIG. 21 is a C-C′ sectional view of the display panel of the eleventh embodiment.

FIG. 22 is a D-D′ sectional view of the display panel of the twelfth embodiment.

FIG. 23 is a sectional view of a display panel of a thirteenth embodiment.

FIG. 24 is a sectional view of a display panel of a fourteenth embodiment.

FIG. 25 is a plan view illustrating a configuration of a display panel.

FIG. 26 is a plan view illustrating a configuration of a display panel.

FIG. 27 is a plan view illustrating a configuration of a display panel.

FIG. 28 is a plan view illustrating a configuration of a display panel.

FIG. 29 is a plan view illustrating a configuration of a display panel.

FIG. 30 is a plan view illustrating a configuration of a display panel.

FIG. 31 is a plan view illustrating a configuration of a display panel.

FIG. 32 is a plan view illustrating a configuration of a related-art display panel.

### DETAILED DESCRIPTION

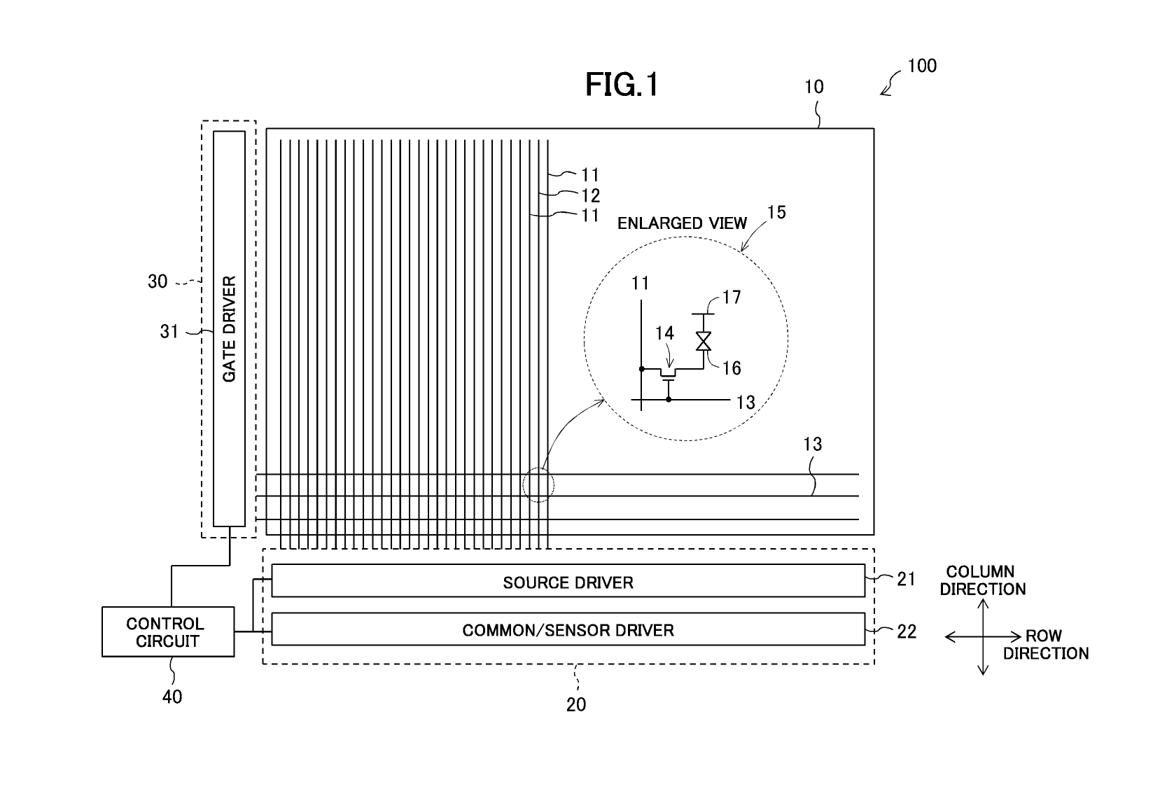

One embodiment of the present application is described below with reference to the attached drawings. FIG. 1 is a plan view illustrating a schematic configuration of a liquid crystal display device according to this embodiment. A liquid crystal display device 100 includes a display panel 10, a first drive circuit 20, a second drive circuit 30, a control circuit 40, a power supply section (not shown), and a backlight unit (not shown). The first drive circuit 20 and the second drive circuit 30 may be included in the display panel 10.

The display panel 10 includes a plurality of data signal lines 11 extending in a column direction, a plurality of sensor electrode lines 12 extending in the column direction, and a plurality of gate signal lines 13 extending in a row direction. The plurality of data signal lines 11 are arranged at substantially equal intervals in the row direction, the plurality of sensor electrode lines 12 are arranged at substantially equal intervals in the row direction, and the plurality of gate signal lines 13 are arranged at substantially equal intervals in the column direction. Each sensor electrode line 12 is arranged between adjacent two of the data signal lines 11 in plan view. In each intersecting portion between each data signal line 11 and each gate signal line 13, a thin film transistor 14 (TFT) is formed.

The first drive circuit 20 includes a source driver 21 for outputting a data signal (display voltage) to each of the data signal lines 11, and a common/sensor driver 22 for outputting a common voltage Vcom and a sensor voltage to each of the sensor electrode lines 12. The source driver 21 and the common/sensor driver 22 may be formed of a single integrated circuit (IC), or may be formed of two ICs independent of each other. The second drive circuit 30 includes a gate driver 31 for outputting a gate signal (scanning signal) to each of the gate signal lines 13.

In the display panel 10, a plurality of pixels 15 are arranged in matrix (in row direction and column direction) to correspond to each intersecting portion between each data signal line 11 and each gate signal line 13. Although the details are described later, the display panel 10 includes a thin film transistor substrate (TFT substrate), a color filter substrate (CF substrate), and a liquid crystal layer sandwiched between both the substrates. In the TFT substrate, pixel electrodes 16 are arranged to correspond to respective pixels 15. Further, the TFT substrate includes common electrodes 17 arranged at a ratio of one to a plurality of pixels 15. Each common electrode 17 has a function as an electrode for displaying an image, and a function as an electrode for detecting a touch position (sensor electrode). That is, the display panel 10 has an image display function and a touch detection function.

Next, the specific planar structure and sectional structure of the display panel 10 are described. Various planar structures and sectional structures may be applied to the display panel 10. Description of configurations common to respective embodiments described below is omitted as appropriate. First and second embodiments each have a structure in which the common electrode 17 (sensor electrode) is arranged in a lower layer (back surface side), and the pixel electrode 16 is arranged in an upper layer (display surface side). Third and fourth embodiments each have a structure in which the pixel electrode 16 is arranged in a lower layer (back surface side), and the common electrode 17 (sensor electrode) is arranged in an upper layer (display surface side).

### First Embodiment

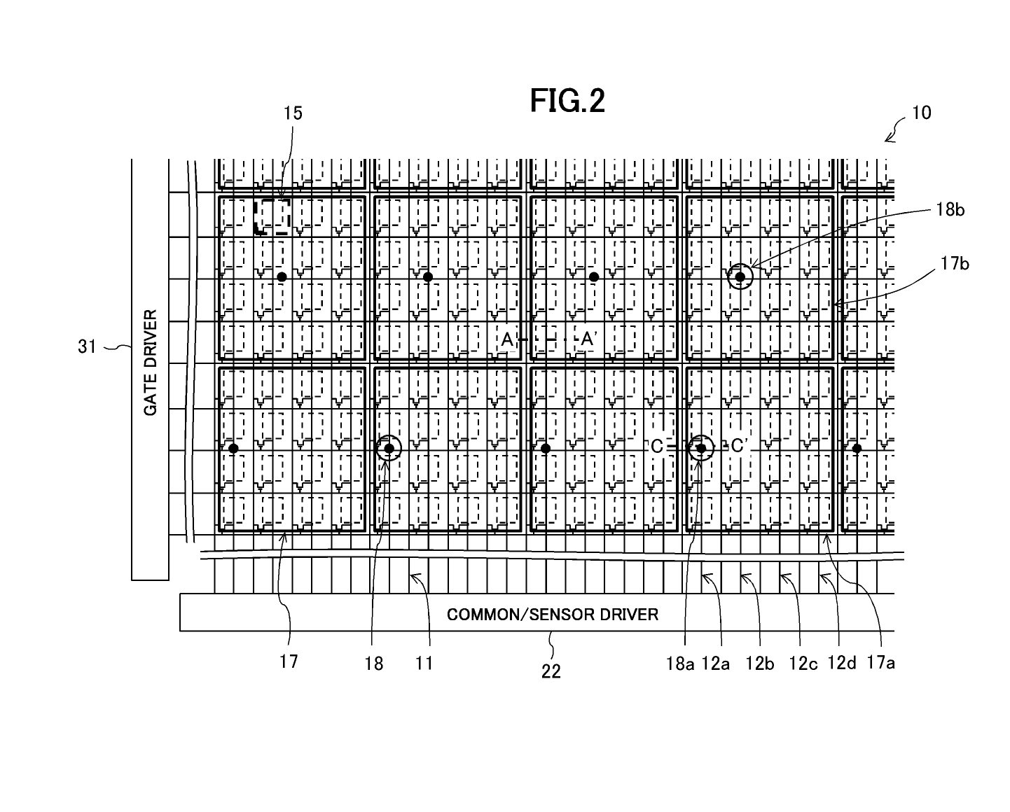

FIG. 2 is a plan view illustrating details of a display panel 10 of the first embodiment. In FIG. 2, for the sake of easy understanding of the description, the source driver 21 is omitted. In the configuration illustrated in FIG. 2, the plurality of common electrodes 17 are arranged at a ratio of one to a total of sixteen pixels 15 including four pixels 15 in the column direction and four pixels 15 in the row direction. The plurality of common electrodes 17 each have the substantially same shape, and are arrayed regularly. The sensor electrode lines 12 are arranged in the TFT substrate between adjacent two of the data signal lines 11 in plan view. In plan view, each of the common electrodes 17 overlaps with the plurality of sensor electrode lines 12, and is electrically connected to one of the plurality of sensor electrode lines 12 via a through hole (contact hole) 18. In the configuration illustrated in FIG. 2, a common electrode 17a overlaps with four sensor electrode lines 12a, 12b, 12c, and 12d, and is electrically connected to one sensor electrode line 12a among those sensor electrode lines via a through hole 18a. Further, a common electrode 17b overlaps with the four sensor electrode lines 12a, 12b, 12c, and 12d, and is electrically connected to one sensor electrode line 12b among those sensor electrode lines via a through hole 18b.

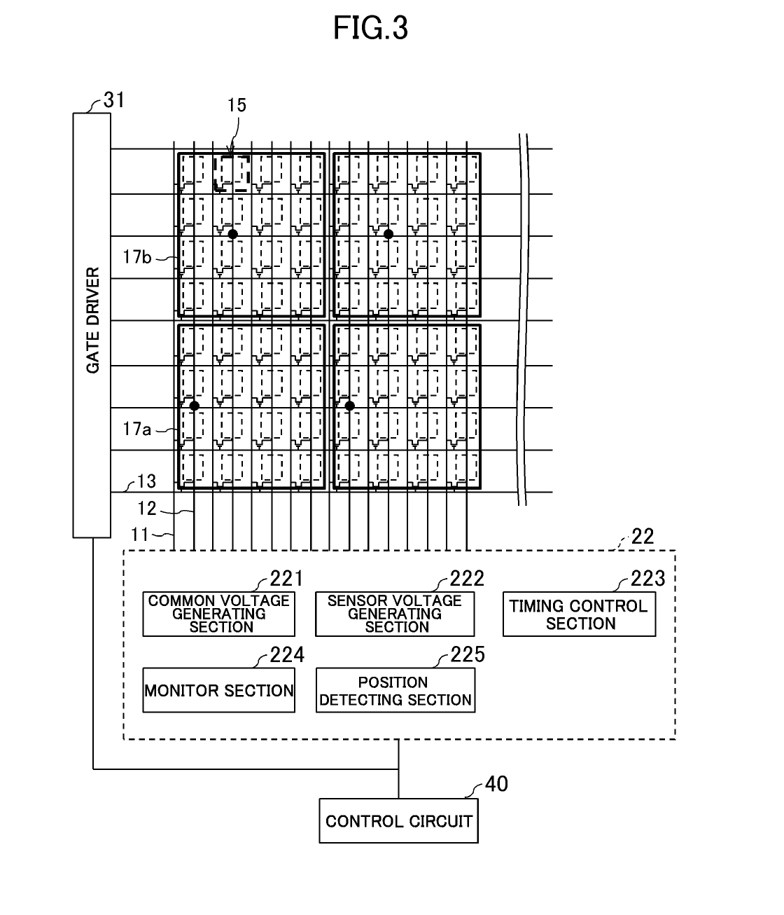

FIG. 3 is a block diagram illustrating a configuration of the common/sensor driver 22 of the first embodiment. Note that, the configuration of the common/sensor driver 22 is common to the display panels 10 of the following respective embodiments. In FIG. 3, for the sake of easy understanding of the description, the source driver 21 is omitted. The common/sensor driver 22 includes a common voltage generating section 221, a sensor voltage generating section 222, a timing control section 223, a monitor section 224, and a position detecting section 225. The configuration of the common/sensor driver 22 is not limited thereto, and a well-known configuration can be adopted.

The common voltage generating section 221 generates the common voltage Vcom (reference voltage) for image display. The common/sensor driver 22 supplies the above-mentioned generated common voltage to the common electrode 17 via the sensor electrode line 12 during a writing period for supplying a data signal (display voltage) to the pixel electrode 16. The sensor voltage generating section 222 generates the sensor voltage for detecting the touch position. The common/sensor driver 22 supplies the above-mentioned generated sensor voltage to the common electrode 17 via the sensor electrode line 12 during a non-writing period after the above-mentioned writing period. The timing control section 223 controls timing for the common/sensor driver 22 to output the above-mentioned common voltage and the above-mentioned sensor voltage based on a timing signal (horizontal synchronization signal and vertical synchronization signal) received from the control circuit 40. The monitor section 224 monitors (measures) a current (charge) when the sensor voltage is supplied to the common electrode 17. The position detecting section 225 detects the coordinates of the touch position based on the measurement result of the monitor section 224. Note that, in FIG. 3, the position detecting section 225 is included in the common/sensor driver 22, but maybe included in the control circuit 40.

An example of a method of detecting the touch position is described. The liquid crystal display device 100 detects the touch position by means of a self-capacitance method of a capacitive system. Specifically, when a finger approaches the surface of the display panel 10, a capacitance is generated between the common electrode (sensor electrode) and the finger. When the capacitance is generated, a parasitic capacitance at the common electrode is increased, and a current (charge) is increased when the sensor voltage is supplied to the common electrode 17. The common/sensor driver 22 detects the position (coordinates) of the contact (touch) to the display panel based on the variation amount of this current (charge). Note that, a well-known method may be applied to the method of detecting the touch position by the self-capacitance method. For example, as in U.S. Pat. No. 8,766,950, the touch position may be detected during a non-display period.

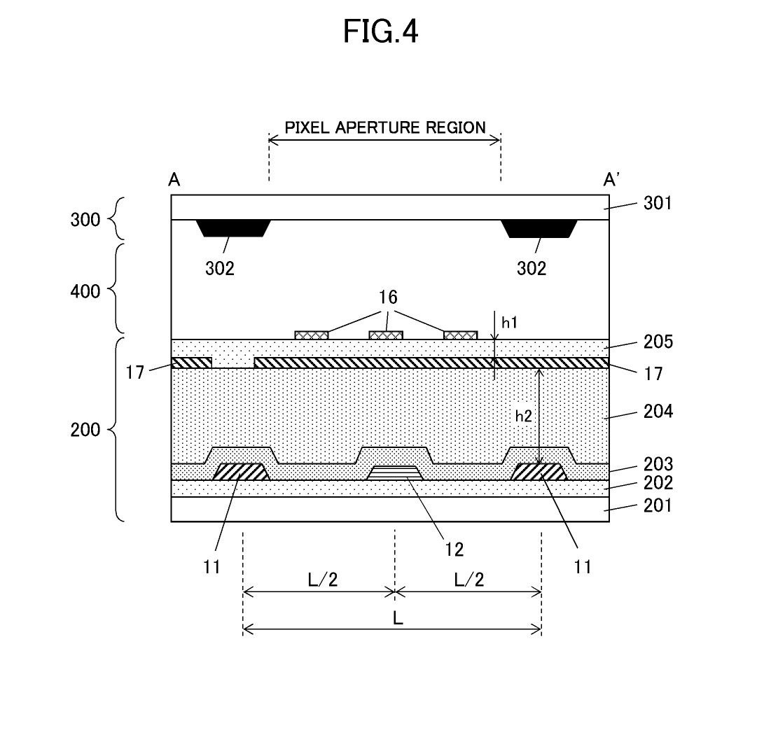

FIG. 4 is a sectional view taken along the line A-A′ of FIG. 2 in the display panel 10 of the first embodiment. The display panel 10 includes a TFT substrate 200, a color filter (CF) substrate 300, and a liquid crystal layer 400 sandwiched between both the substrates.

In the TFT substrate 200, the plurality of gate signal lines 13 (not shown) are formed on a glass substrate 201, a first insulating film 202 is formed so as to cover the plurality of gate signal lines 13, the plurality of data signal lines 11 and the plurality of sensor electrode lines 12 are formed on the first insulating film 202, a second insulating film 203 is formed so as to cover the plurality of data signal lines 11 and the plurality of sensor electrode lines 12, and a third insulating film 204 is formed on the second insulating film 203. The third insulating film 204 is made of, for example, a photosensitive organic material containing acrylic as a main component. The plurality of common electrodes 17 (sensor electrodes) are formed on the third insulating film 204, a fourth insulating film 205 is formed so as to cover the plurality of common electrodes 17, and a plurality of the pixel electrodes 16 are formed on the fourth insulating film 205. Although not shown, outside the pixel aperture region, the through hole 18(see FIG. 2) is formed through a part of the second insulating film 203 and a part of the third insulating film 204. The sensor electrode line 12 is arranged at a position with a substantially equal distance (L/2) from each of adjacent two of the data signal lines 11 (center of the pixel region). The sensor electrode line 12 is electrically connected to the common electrode 17 via the through hole 18. The second insulating film 203 and the third insulating film 204 are arranged between the sensor electrode line 12 and the common electrode 17, and hence the sensor electrode line 12 is not electrically connected to the common electrodes 17 other than the common electrode 17 electrically connected to the sensor electrode line 12 via the through hole 18. The pixel electrode 16 has slits formed therein. Note that, although not shown, an alignment film is formed on the pixel electrodes 16, and a polarizing plate is formed on the outer side of the glass substrate 201. A liquid crystal capacitance Clc is formed between the pixel electrode 16 and the common electrode 17.

In the CF substrate 300, a black matrix 302 is formed on a glass substrate 301. Although not shown, a color filter is formed on the glass substrate 301, an overcoat film is formed so as to cover the color filter, and an alignment film is formed on the overcoat film. A polarizing plate is formed on the outer side of the CF substrate 300.

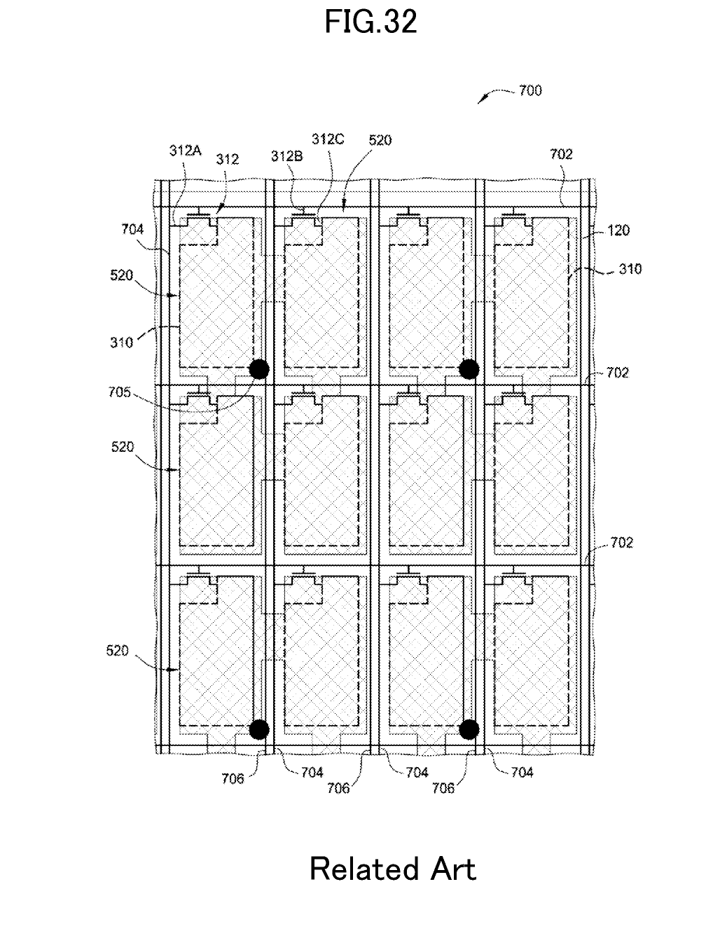

The liquid crystal display device 100 applies an electric field generated between the pixel electrode 16 and the common electrode 17 to the liquid crystal layer 400 to drive the liquid crystal, thereby adjusting the amount of light passing through the liquid crystal layer 400 to display an image. With the configuration of the first embodiment, the sensor electrode line 12 is arranged in the same layer as the data signal line 11, and hence the number of wiring layers can be reduced. Therefore, the manufacturing process can be simplified, and the product cost can be reduced. Further, the common electrode 17 is formed on the third insulating film 204 being an organic insulating film. Further, the sensor electrode line 12 is arranged at a position with a substantially equal distance (L/2) from each of adjacent two of the data signal lines 11. Therefore, as compared to the related-art configuration (FIG. 32) in which the sensor electrode line 706 is formed in proximity to the source line 704, the influence of the electric field from the data signal line 11 can be reduced. Therefore, the detection accuracy of the touch position can be improved.

Further, with the above-mentioned configuration, a distance h1 between the pixel electrode 16 and the common electrode 17 can be decreased, and thus a liquid crystal capacitance Clc to be formed between the pixel electrode 16 and the common electrode 17 can be increased. Therefore, the display quality can be improved. Further, a distance h2 between the sensor electrode line 12 and the common electrode 17 (sensor electrode) can be increased, and hence a parasitic capacitance to be formed between the sensor electrode line 12 and the common electrode 17 can be decreased. The above-mentioned parasitic capacitance refers to a capacitance formed due to the structure between the common electrode 17 and the sensor electrode line 12 passing along the common electrode 17. For example, in FIG. 2, when the common electrode 17b is focused on, the above-mentioned parasitic capacitance refers to a parasitic capacitance formed between the common electrode 17b and each of the sensor electrode lines 12a, 12c, and 12d. This parasitic capacitance is increased as the distance h2 between the common electrode 17b and each of the sensor electrode lines 12a, 12c, and 12d is decreased, and is decreased as the distance h2 is increased. With the configuration of the first embodiment, the distance h2 can be increased, and hence the parasitic capacitance between the sensor electrode line 12 and the common electrode 17 can be decreased. Therefore, the detection accuracy of the touch position can be improved.

### Second Embodiment

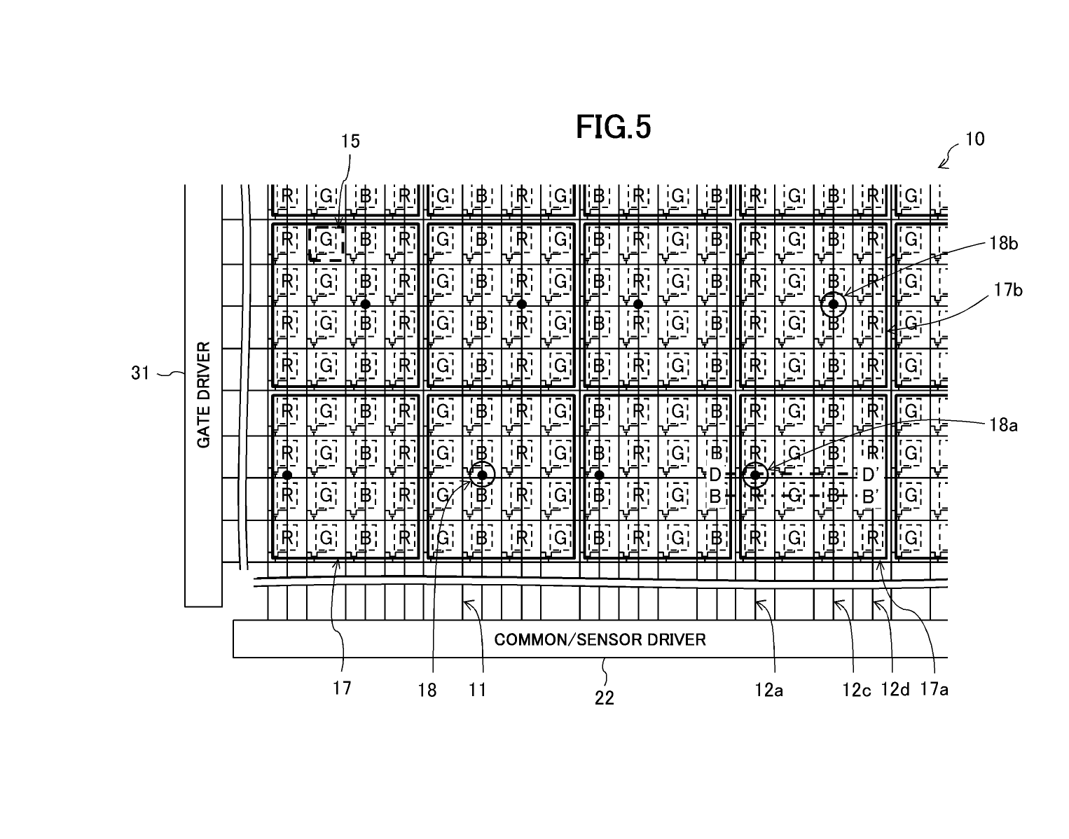

FIG. 5 is a plan view illustrating details of a display panel 10 of the second embodiment. In FIG. 5, for the sake of easy understanding of the description, the source driver 21 is omitted. In the TFT substrate, the sensor electrode line 12 is arranged between adjacent two of the data signal lines 11 in plan view. Further, the sensor electrode line 12 is arranged in each of a red pixel (R pixel) for displaying red and a blue pixel (B pixel) for displaying blue, but is not arranged in a green pixel (G pixel) for displaying green. Further, in plan view, each of the common electrodes 17 overlaps with the plurality of sensor electrode lines 12, and is electrically connected to one of the plurality of sensor electrode lines 12 via the through hole (contact hole) 18. In the configuration illustrated in FIG. 5, the common electrode 17a overlaps with three sensor electrode lines 12a, 12c, and 12d, and is electrically connected to one sensor electrode line 12a among those sensor electrode lines via the through hole 18a. Further, the common electrode 17b overlaps with the three sensor electrode lines 12a, 12c, and 12d, and is electrically connected to one sensor electrode line 12c among those sensor electrode lines via the through hole 18b.

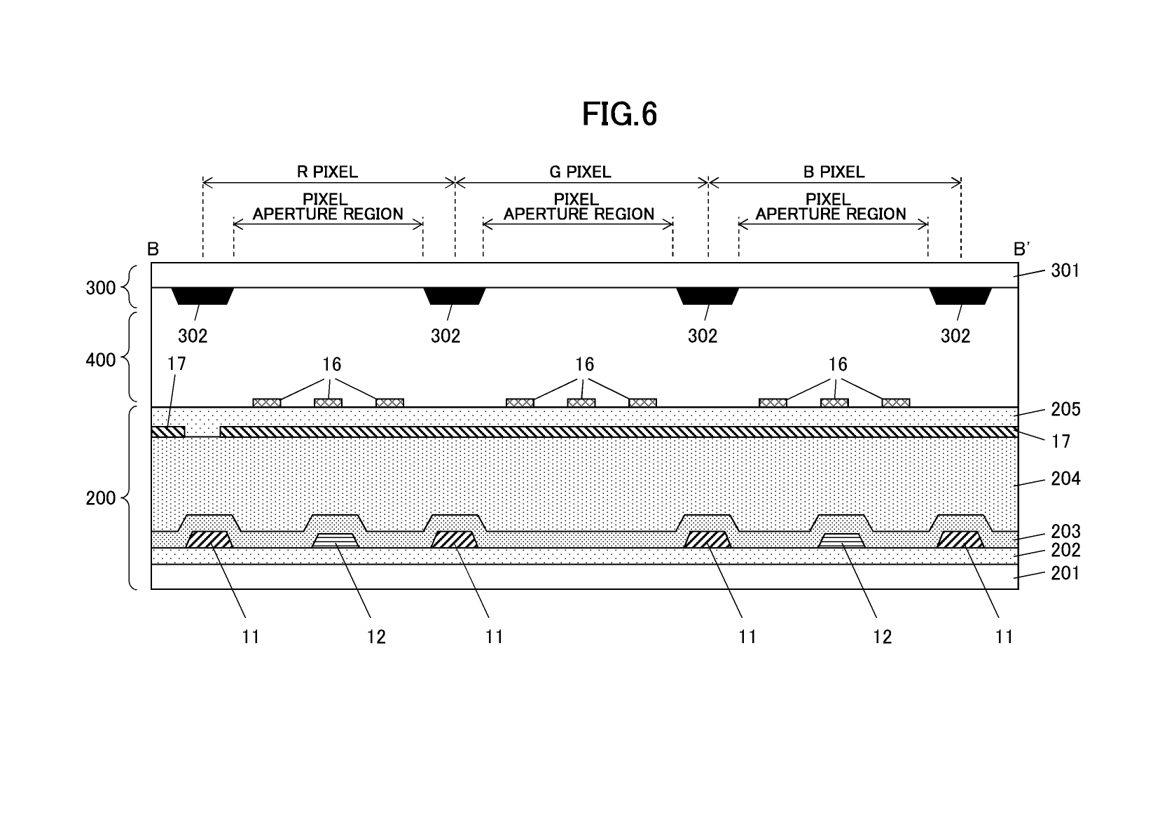

FIG. 6 is a sectional view taken along the line B-B′ of FIG. 5 in the display panel 10 of the second embodiment.

In the TFT substrate 200, the plurality of gate signal lines 13 (not shown) are formed on the glass substrate 201, the first insulating film 202 is formed so as to cover the plurality of gate signal lines 13, the plurality of data signal lines 11 and the plurality of sensor electrode lines 12 are formed on the first insulating film 202, the second insulating film 203 is formed so as to cover the plurality of data signal lines 11 and the plurality of sensor electrode lines 12, and the third insulating film 204 is formed on the second insulating film 203. The third insulating film 204 is made of, for example, a photosensitive organic material containing acrylic as a main component. The plurality of common electrodes 17 (sensor electrodes) are formed on the third insulating film 204, the fourth insulating film 205 is formed so as to cover the plurality of common electrodes 17, and the plurality of pixel electrodes 16 are formed on the fourth insulating film 205. Although not shown, outside the pixel aperture region, the through hole 18 is formed through a part of the second insulating film 203 and a part of the third insulating film 204. The sensor electrode line 12 is arranged between adjacent two of the data signal lines 11 in each of the R pixel and the B pixel, but is not arranged in the G pixel. Each of the sensor electrode lines 12 arranged in the R pixel and the B pixel is electrically connected to each common electrode 17 via each through hole 18. The second insulating film 203 and the third insulating film 204 are arranged between the sensor electrode line 12 and the common electrode 17, and hence the sensor electrode line 12 is not electrically connected to the common electrodes 17 other than the common electrode 17 electrically connected to the sensor electrode line 12 via the through hole 18. Other configurations are the same as those in the display panel of the first embodiment.

With the configuration of the second embodiment, the sensor electrode line 12 is not arranged in the G pixel that has the largest influence on brightness. Thus, the above-mentioned effects in the display panel 10 of the first embodiment can be obtained, and the display quality can be further improved.

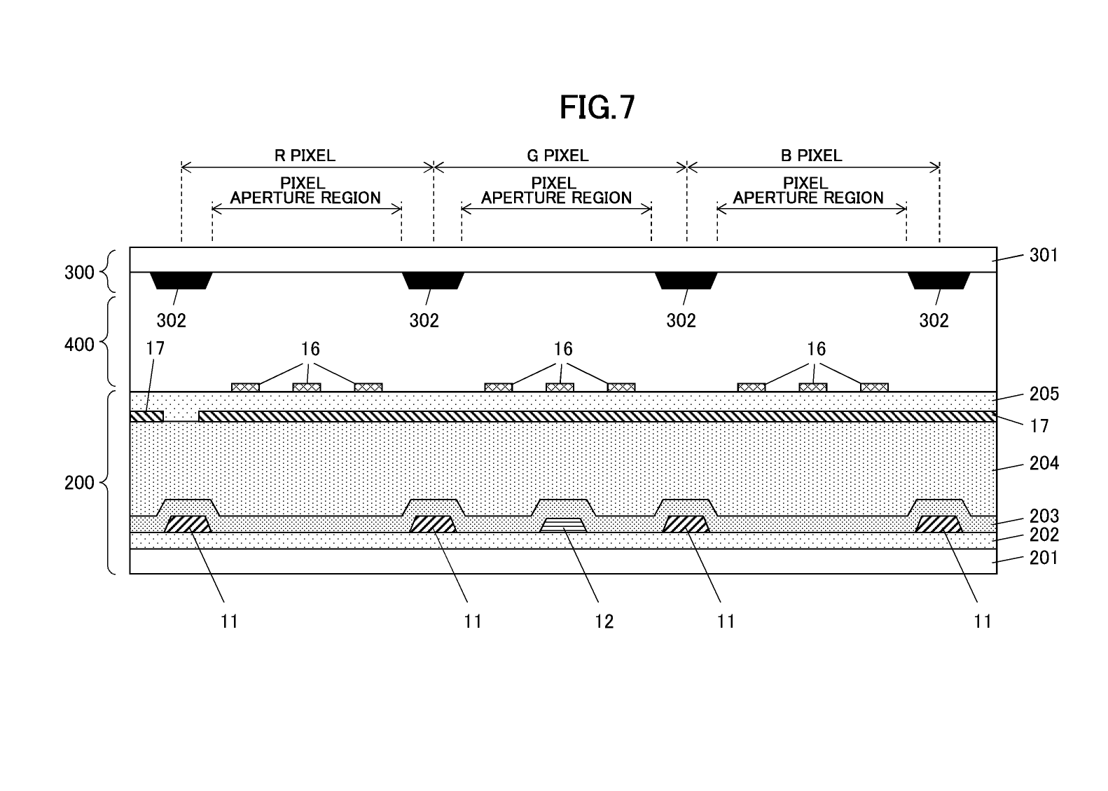

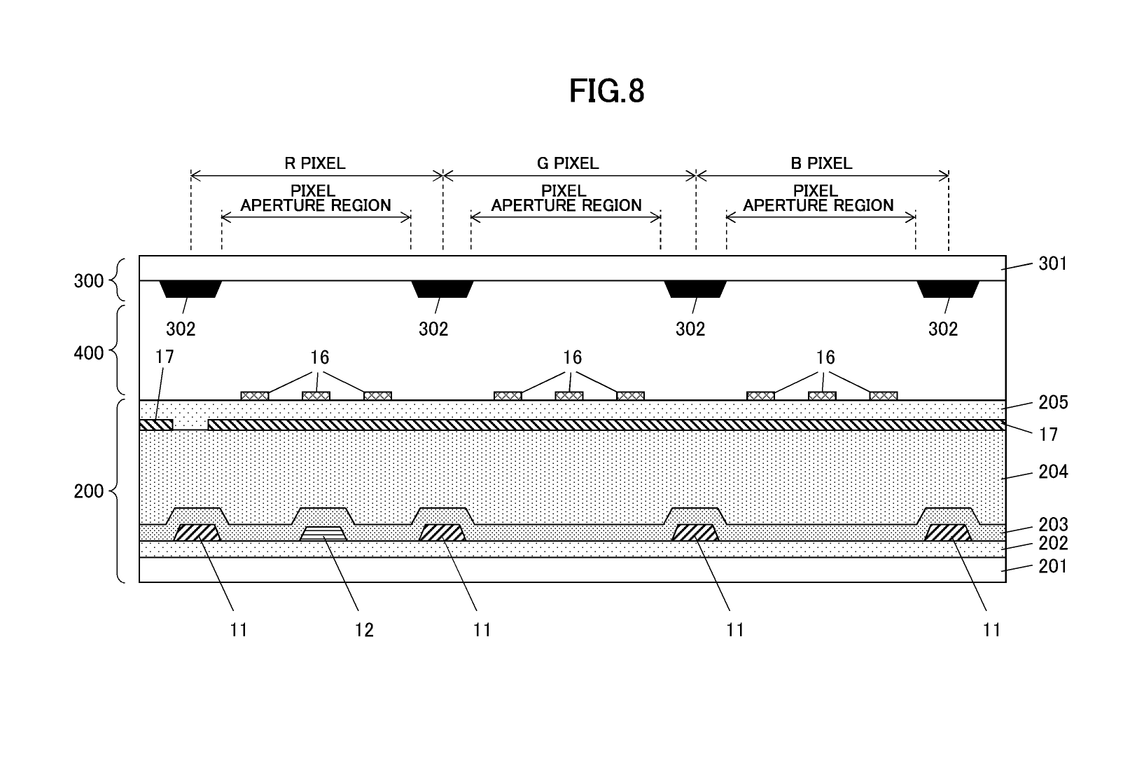

The arrangement configuration of the sensor electrode lines 12 is not limited to the above-mentioned configuration. For example, as illustrated in FIG. 7, the sensor electrode line 12 maybe arranged in the G pixel, but may not be arranged in the R pixel or the B pixel. With this configuration, the brightness of the R pixel and the brightness of the B pixel become relatively higher than the brightness of the G pixel, and hence the color temperature can be increased. Further, as illustrated in FIG. 8, the sensor electrode line 12 may be arranged in the R pixel, but may not be arranged in the G pixel or the B pixel. The respective arrangement configurations of the sensor electrode lines 12 described above can be determined in accordance with the product specification.

The display panel 10 of each of the third and fourth embodiments described below has a structure in which the pixel electrode 16 is arranged in a lower layer and the common electrode 17 (sensor electrode) is arranged in an upper layer.

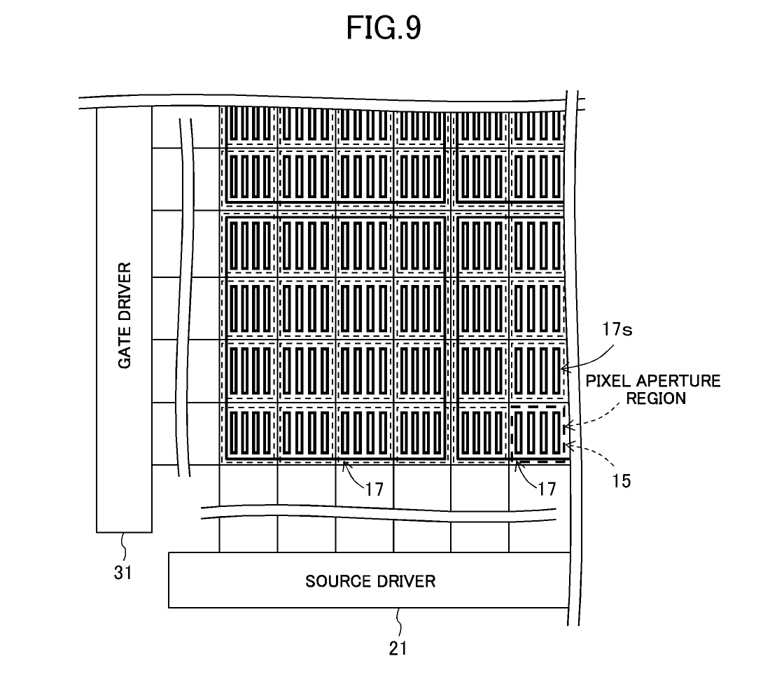

FIG. 9 is a plan view illustrating the configuration of the common electrodes 17 in the display panel 10 of each of the third and fourth embodiments. The common electrodes 17 are arranged at a ratio of one to sixteen pixels 15. Slits 17s are formed in a pixel aperture region of each of the common electrodes 17. The number of the slits 17s formed in a single pixel aperture region is not limited.

### Third Embodiment

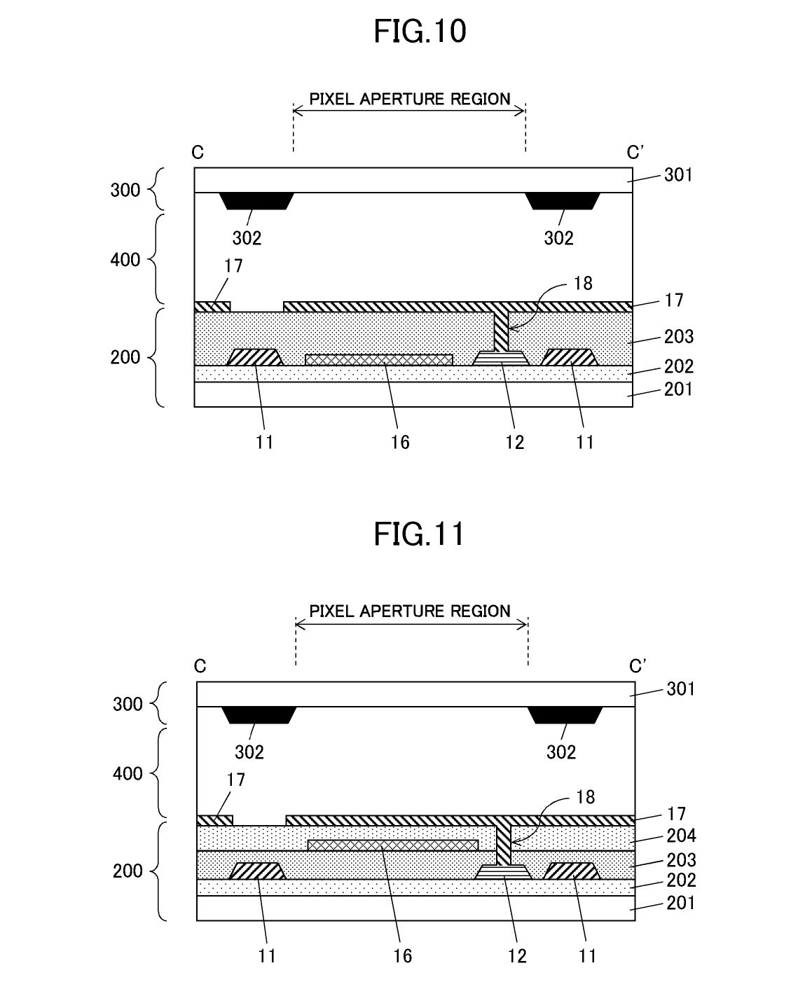

FIG. 10 is a sectional view taken along the line C-C′ of FIG. 2 in a display panel 10 of the third embodiment. Note that, in FIG. 2, the slits 17s are omitted.

In the TFT substrate 200, the plurality of gate signal lines 13 (not shown) are formed on the glass substrate 201, the first insulating film 202 is formed so as to cover the plurality of gate signal lines 13, and the plurality of data signal lines 11, the plurality of pixel electrodes 16, and the plurality of sensor electrode lines 12 are formed in the same layer on the first insulating film 202. The second insulating film 203 is formed so as to cover the plurality of data signal lines 11, the plurality of pixel electrodes 16, and the plurality of sensor electrode lines 12, and the through hole 18 is formed through a part of the second insulating film 203. The plurality of common electrodes 17 are formed on the second insulating film 203 and inside the through hole 18. The sensor electrode line 12 is electrically connected to the common electrode 17 via the through hole 18. The second insulating film 203 is arranged between the sensor electrode line 12 and the common electrode 17, and hence the sensor electrode line 12 is not electrically connected to the common electrodes 17 other than the common electrode 17 electrically connected to the sensor electrode line 12 via the through hole 18. In parts of the common electrode 17, which substantially overlap with the pixel aperture region, the slits 17s (see FIG. 9) are formed. Other configurations are the same as those in the display panel of the first embodiment.

With the configuration of the third embodiment, the sensor electrode line 12, the data signal line 11, and the pixel electrode 16 are arranged in the same layer, and hence the number of wiring layers can be reduced. Therefore, the manufacturing process can be simplified, and the product cost can be reduced. Further, the common electrode 17 is arranged in a layer close to the touch surface (on the display surface side), and hence the detection accuracy of the touch position can be improved.

The layer in which the pixel electrode 16 is arranged is not limited to the above-mentioned configuration. The pixel electrode 16 may be arranged in a different layer from those of the sensor electrode line 12 and the data signal line 11. For example, as illustrated in FIG. 11, the plurality of data signal lines 11 and the plurality of sensor electrode lines 12 are formed in the same layer on the first insulating film 202, the second insulating film 203 is formed so as to cover the plurality of data signal lines 11 and the plurality of sensor electrode lines 12, and the plurality of pixel electrodes 16 are formed on the second insulating film 203. The third insulating film 204 is formed so as to cover the plurality of pixel electrodes 16, and the through hole 18 is formed through a part of the second insulating film 203 and a part of the third insulating film 204. The plurality of common electrodes 17 are formed on the third insulating film 204 and inside the through hole 18. Note that, the pixel electrode 16 is electrically connected to the data signal line 11 via a through hole (not shown).

With the configuration of FIG. 11, the sensor electrode line 12 and the data signal line 11 are arranged in the same layer. Therefore, as compared to the case where the sensor electrode line 12 and the data signal line 11 are arranged in different layers from each other, the number of wiring layers can be reduced. Further, the distance between the pixel electrode 16 and the common electrode 17 can be reduced, and hence the liquid crystal capacitance Clc to be formed between the pixel electrode 16 and the common electrode 17 can be increased. Therefore, the display quality can be improved.

### Fourth Embodiment

The planar configuration of a display panel 10 of the fourth embodiment is the same as the planar configuration of the display panel of the second embodiment (see FIG. 5). That is, in the TFT substrate, the sensor electrode line 12 is arranged between adjacent two of the data signal lines 11 in plan view. Further, the sensor electrode line 12 is arranged in each of the red pixel (R pixel) and the blue pixel (B pixel), but is not arranged in the green pixel (G pixel).

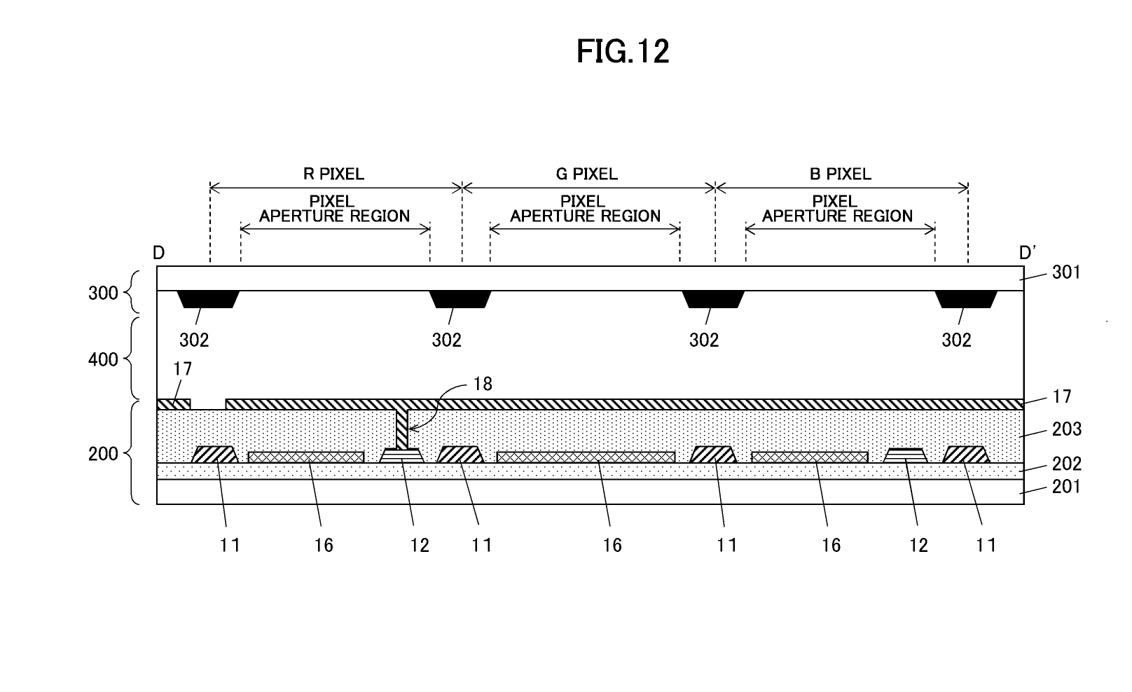

FIG. 12 is a sectional view taken along the line D-D′ of FIG. 5 in the display panel 10 of the fourth embodiment. Note that, in FIG. 2, the slits 17s are omitted.

In the TFT substrate 200, the plurality of gate signal lines 13 (not shown) are formed on the glass substrate 201, the first insulating film 202 is formed so as to cover the plurality of gate signal lines 13, and the plurality of data signal lines 11, the plurality of pixel electrodes 16, and the plurality of sensor electrode lines 12 are formed in the same layer on the first insulating film 202. The sensor electrode line 12 is arranged between adjacent two of the data signal lines 11 in each of the R pixel and the B pixel, but is not arranged in the G pixel. The second insulating film 203 is formed so as to cover the plurality of data signal lines 11, the plurality of pixel electrodes 16, and the plurality of sensor electrode lines 12, and the through hole 18 is formed through a part of the second insulating film 203. The plurality of common electrodes 17 are formed on the second insulating film 203 and inside the through hole 18. The sensor electrode line 12 is electrically connected to the common electrode 17 via the through hole 18. The second insulating film 203 is arranged between the sensor electrode line 12 and the common electrode 17, and hence the sensor electrode line 12 is not electrically connected to the common electrodes 17 other than the common electrode 17 electrically connected to the sensor electrode line 12 via the through hole 18. In parts of the common electrode 17, which substantially overlap with the pixel aperture region, the slits 17s (see FIG. 9) are formed. As illustrated in FIG. 12, the sensor electrode line 12 arranged in the R pixel is electrically connected to the common electrode 17 via the through hole 18. The sensor electrode line 12 arranged in the B pixel is electrically connected to another common electrode 17 via another through hole 18. Other configurations are the same as those in the display panel of the first embodiment.

With the configuration of the fourth embodiment, the sensor electrode line 12 is not arranged in the G pixel that has the largest influence on brightness. Thus, the above-mentioned effects in the display panel 10 of the third embodiment can be obtained, and the display quality can be further improved. Note that, as illustrated in FIG. 11, the pixel electrode 16 may be arranged in a layer above the sensor electrode line 12 and the data signal line 11 (on the common electrode 17 side).

The display panel 10 of each of the above-mentioned first to fourth embodiments may include shielding wiring for preventing electric field leakage from a gap between adjacent common electrodes 17. The display panel 10 of each of fifth to eighth embodiments described below includes the above-mentioned shielding wiring in the display panel 10 of each of the first to fourth embodiments.

### Fifth Embodiment

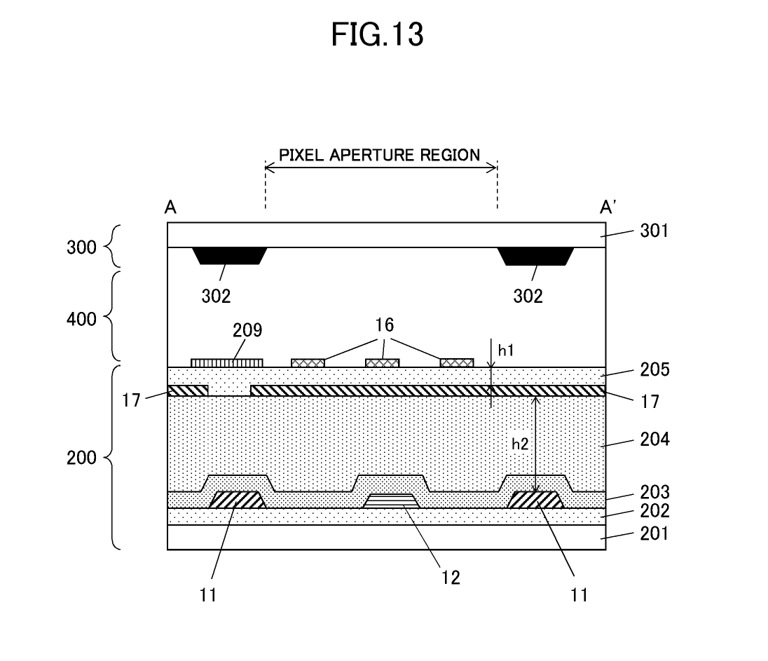

FIG. 13 is a sectional view taken along the line A-A′ of FIG. 2 in a display panel 10 of the fifth embodiment. The display panel 10 of the fifth embodiment is formed as follows. In the display panel 10 of the first embodiment (see FIG. 4), shielding wiring 209 is arranged so as to cover the gap between the adjacent common electrodes 17 (sensor electrodes) in plan view. With the above-mentioned configuration, it is possible to prevent the leakage electric field from the data signal line 11 from reaching the liquid crystal layer 400 through the gap between the adjacent common electrodes 17. Therefore, it is possible to prevent reduction in display quality due to image disturbance caused by the leakage electric field.

### Sixth Embodiment

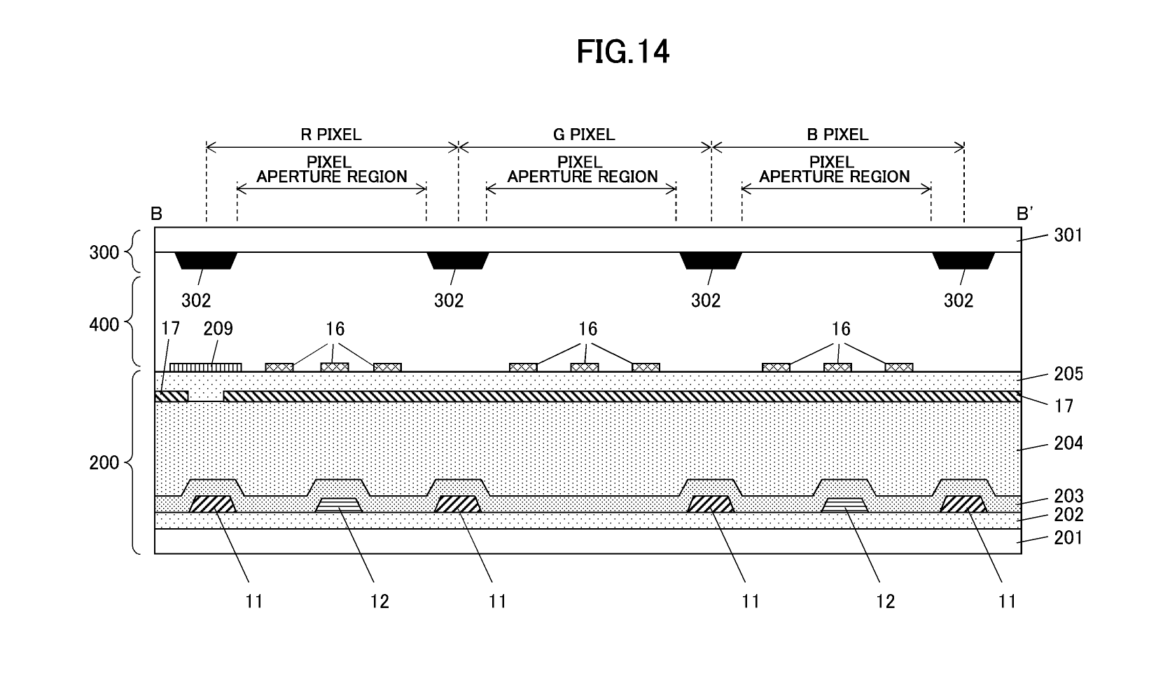

FIG. 14 is a sectional view taken along the line B-B′ of FIG. 5 in a display panel 10 of the sixth embodiment. The display panel 10 of the sixth embodiment is formed as follows. In the display panel 10 of the second embodiment (see FIG. 6), the shielding wiring 209 is arranged so as to cover the gap between the adjacent common electrodes 17 (sensor electrodes). With the above-mentioned configuration, similarly to the display panel 10 of the fifth embodiment, it is possible to prevent reduction in display quality due to image disturbance caused by the leakage electric field.

### Seventh Embodiment

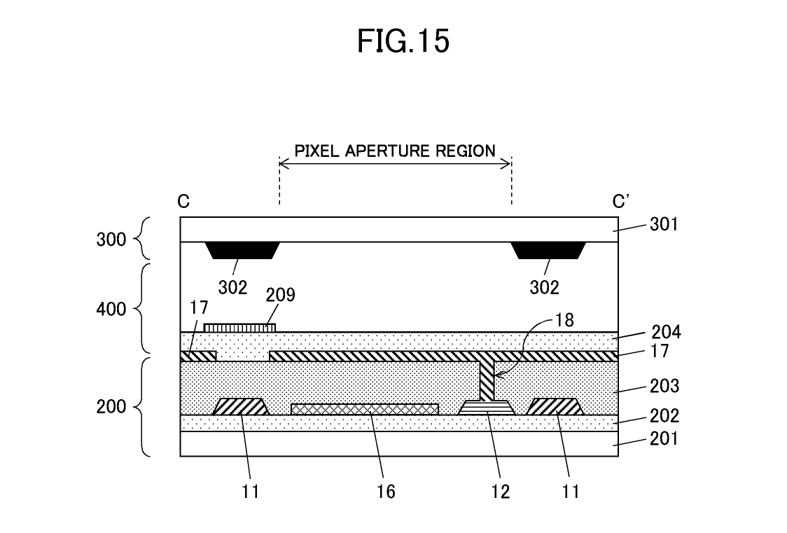

FIG. 15 is a sectional view taken along the line C-C′ of FIG. 2 in a display panel 10 of the seventh embodiment. The display panel 10 of the seventh embodiment is formed as follows. In the display panel 10 of the third embodiment (see FIG. 6), the shielding wiring 209 is arranged on the third insulation film 204 so as to cover the gap between the adjacent common electrodes 17 (sensor electrodes). With the above-mentioned configuration, similarly to the display panel 10 of the fifth embodiment, it is possible to prevent reduction in display quality due to image disturbance caused by the leakage electric field.

### Eighth Embodiment

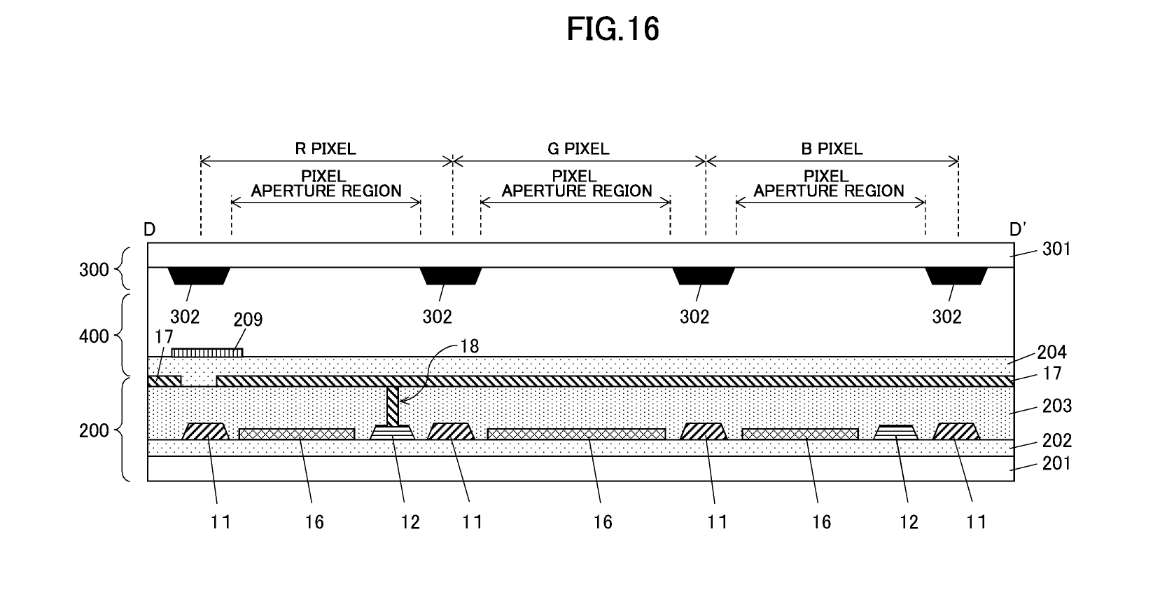

FIG. 16 is a sectional view taken along the line D-D′ of FIG. 5 in a display panel 10 of the eighth embodiment. The display panel 10 of the eighth embodiment is formed as follows. In the display panel 10 of the fourth embodiment (see FIG. 12), the shielding wiring 209 is arranged on the third insulation film 204 so as to cover the gap between the adjacent common electrodes 17 (sensor electrodes). With the above-mentioned configuration, similarly to the display panel 10 of the fifth embodiment, it is possible to prevent reduction in display quality due to image disturbance caused by the leakage electric field.

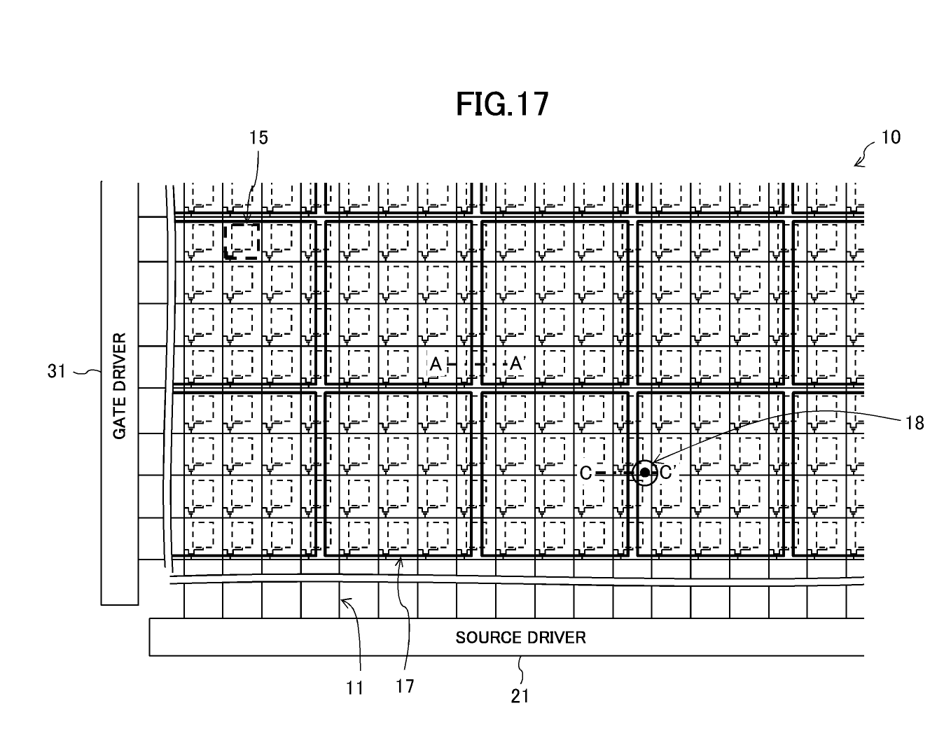

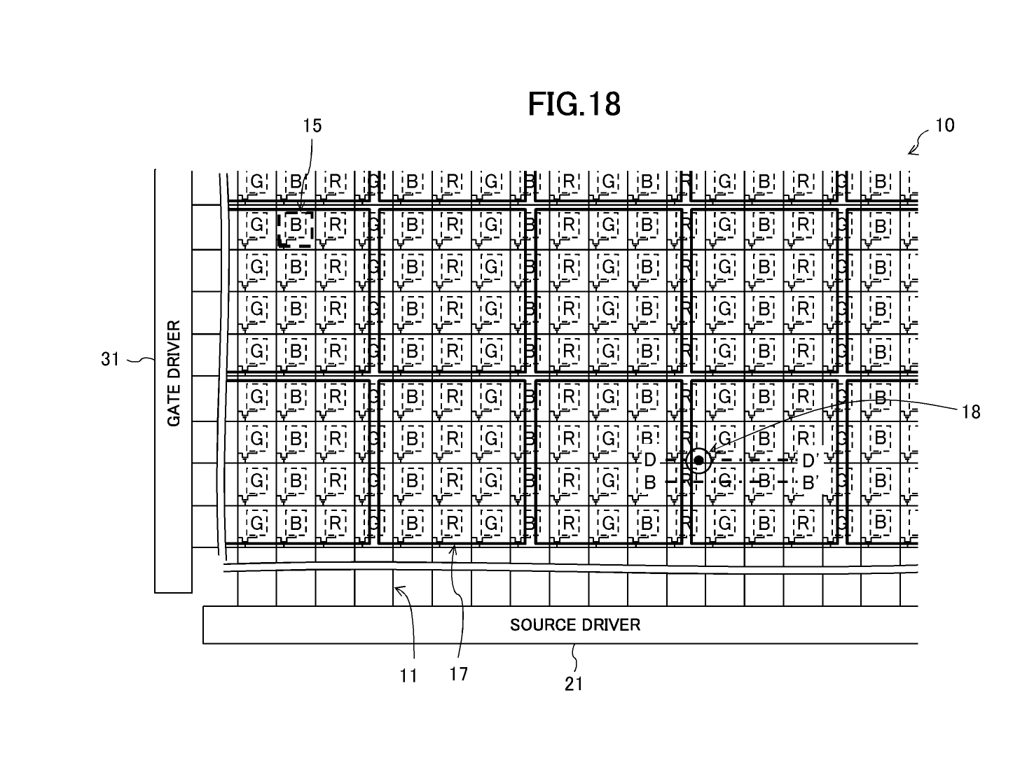

In the above-mentioned display panel 10 of each of the first to eighth embodiments, the plurality of common electrodes 17 are arranged so that the gap between the adjacent common electrodes 17 overlaps with the gap between adjacent pixels in plan view. However, in the display panel 10 according to this embodiment, the arrangement of the common electrodes 17 is not limited to the above-mentioned configuration (arrangement). For example, the plurality of common electrodes 17 may be arranged so that the gap between the adjacent common electrodes 17 is positioned in the vicinity of the center of the pixel region (or in the pixel aperture region). The display panel 10 of each of ninth to twelfth embodiments described below has the above-mentioned configuration (arrangement). FIG. 17 is a plan view illustrating a configuration common to the display panels 10 of the ninth and tenth embodiments. FIG. 18 is a plan view illustrating a configuration common to the display panels 10 of the eleventh and twelfth embodiments. In FIGS. 17 and 18, for the sake of easy understanding of the description, the common/sensor driver 22 and the sensor electrode lines 12 are omitted.

### Ninth Embodiment

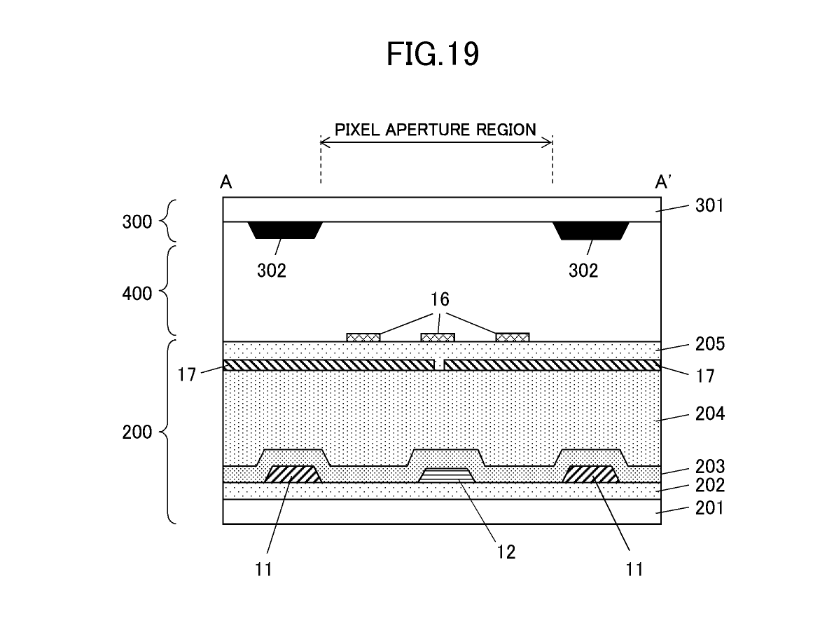

FIG. 19 is a sectional view taken along the line A-A′ of FIG. 17 in a display panel 10 of the ninth embodiment. The display panel 10 of the ninth embodiment is formed as follows. In the display panel 10 of the first embodiment (see FIG. 4), the plurality of common electrodes 17 are arranged so that the gap between the adjacent common electrodes 17 is positioned in the pixel aperture region in plan view. With the above-mentioned configuration, the leakage electric field from the data signal line 11 can be blocked by the common electrode 17. Therefore, it is possible to prevent reduction in display quality due to image disturbance caused by the leakage electric field.

### Tenth Embodiment

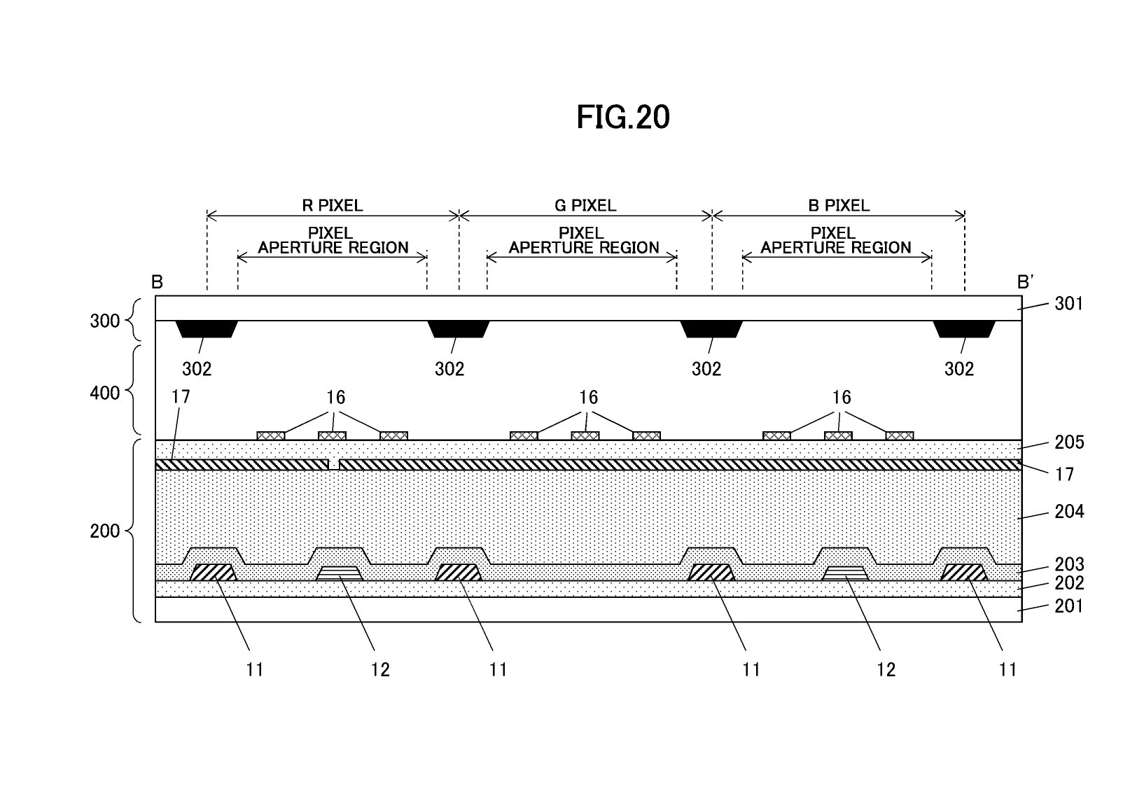

FIG. 20 is a sectional view taken along the line B-B′ of FIG. 18 in a display panel 10 of the tenth embodiment. The display panel 10 of the tenth embodiment is formed as follows. In the display panel 10 of the second embodiment (see FIG. 6), the plurality of common electrodes 17 are arranged so that the gap between the adjacent common electrodes 17 is positioned in the pixel aperture region in plan view. With the above-mentioned configuration, the leakage electric field from the data signal line 11 can be blocked by the common electrode 17. Therefore, it is possible to prevent reduction in display quality due to image disturbance caused by the leakage electric field.

### Eleventh Embodiment

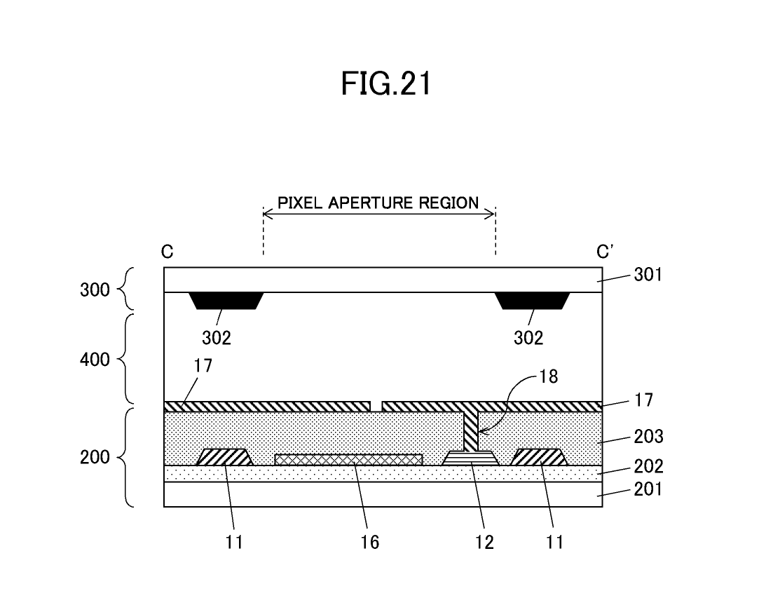

FIG. 21 is a sectional view taken along the line C-C′ of FIG. 17 in a display panel 10 of the eleventh embodiment. The display panel 10 of the eleventh embodiment is formed as follows. In the display panel 10 of the third embodiment (see FIG. 10), the plurality of common electrodes 17 are arranged so that the gap between the adjacent common electrodes 17 is positioned in the pixel aperture region in plan view. With the above-mentioned configuration, the leakage electric field from the data signal line 11 can be blocked by the common electrode 17. Therefore, it is possible to prevent reduction in display quality due to image disturbance caused by the leakage electric field.

### Twelfth Embodiment

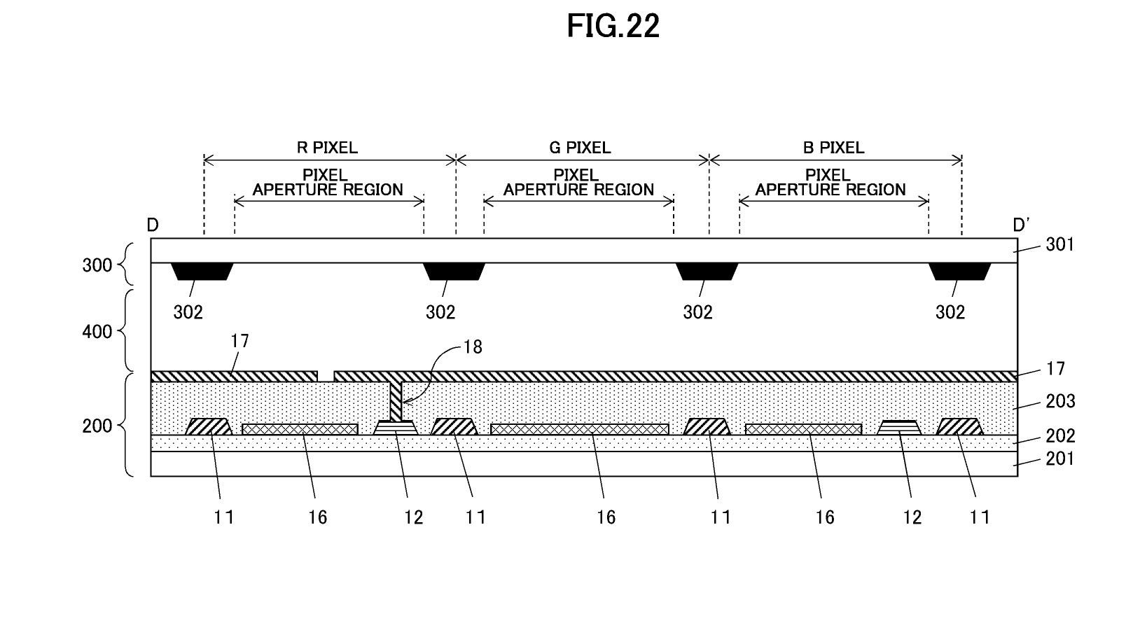

FIG. 22 is a sectional view taken along the line D-D′ of FIG. 18 in a display panel 10 of the twelfth embodiment. The display panel 10 of the twelfth embodiment is formed as follows. In the display panel 10 of the fourth embodiment (see FIG. 12), the plurality of common electrodes 17 are arranged so that the gap between the adjacent common electrodes 17 is positioned in the pixel aperture region in plan view. With the above-mentioned configuration, the leakage electric field from the data signal line 11 can be blocked by the common electrode 17. Therefore, it is possible to prevent reduction in display quality due to image disturbance caused by the leakage electric field.

### Thirteenth Embodiment

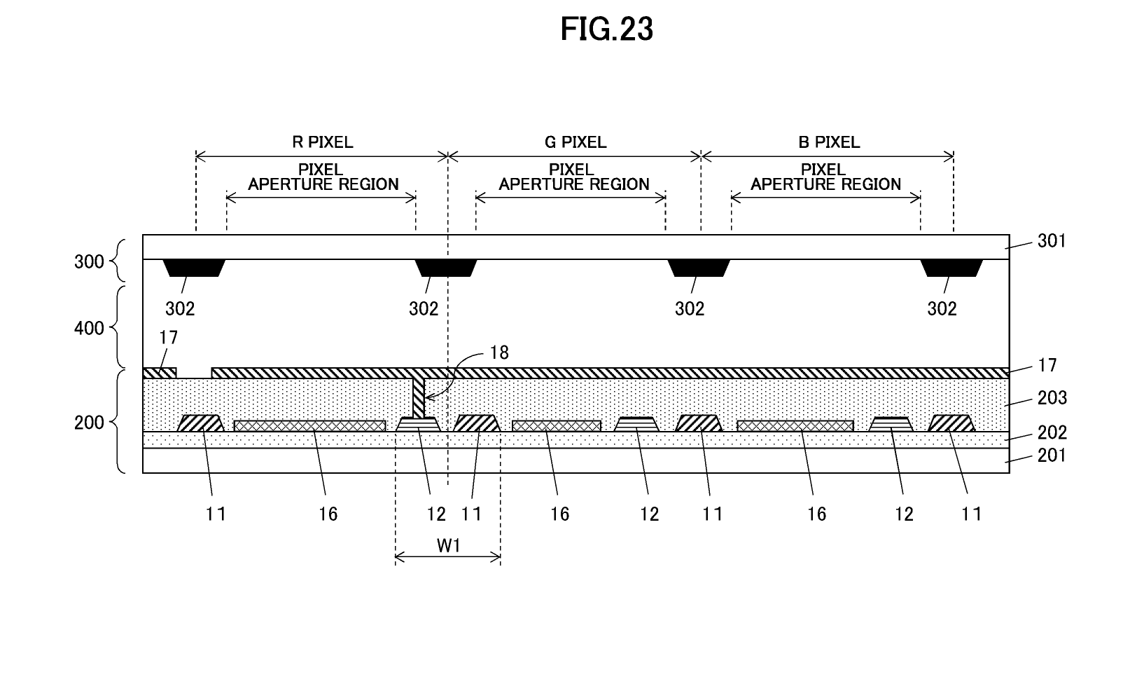

FIG. 23 is a sectional view of a display panel 10 of the thirteenth embodiment. In the display panel 10 of the thirteenth embodiment, at least one of adjacent two of the data signal lines 11 defining the G pixel is arranged to be offset toward the pixel electrode 16 side of the G pixel. That is, the center of the at least one of adjacent two of the data signal lines 11 defining the G pixel is offset toward the pixel electrode 16 side of the G pixel with respect to the center of the black matrix 302. In the example of FIG. 23, the data signal line 11 arranged between the R pixel and the G pixel is arranged to be offset toward the pixel electrode 16 side of the G pixel. The position of the data signal line 11 is not limited, but, for example, in FIG. 23, the data signal line 11 may be arranged at a position at which a center of a width W1 from the left end of the sensor electrode line 12 to the right end of the data signal line 11 substantially matches with the center of the black matrix 302.

With the above-mentioned configuration, the brightness of the R pixel and the brightness of the B pixel become relatively higher than the brightness of the G pixel, and hence the color temperature can be increased. Note that, in FIG. 23, a configuration in which the sensor electrode line 12 is not arranged in the G pixel is illustrated. However, in the display panel of the thirteenth embodiment, the arrangement configuration of the sensor electrode line 12 is not limited, and configurations of other embodiments may be applied as appropriate.

### Fourteenth Embodiment

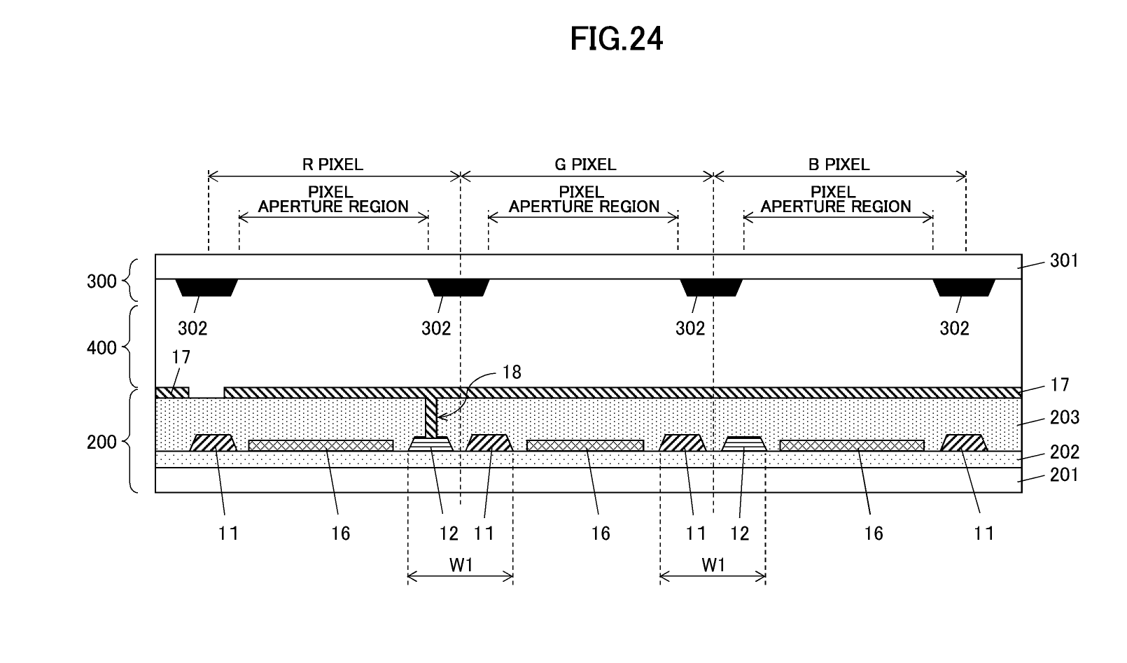

FIG. 24 is a sectional view of a display panel 10 of the fourteenth embodiment. In the display panel 10 of the fourteenth embodiment, the sensor electrode line 12 is arranged in each of the R pixel and the B pixel, but is not arranged in the G pixel. Further, in the R pixel, the sensor electrode line 12 is arranged on the G pixel side with respect to the pixel electrode 16, and in the B pixel, the sensor electrode line 12 is arranged on the G pixel side with respect to the pixel electrode 16. Further, adjacent two of the data signal lines 11 defining the G pixel are arranged to be offset toward the pixel electrode 16 side of the G pixel. That is, the centers of adjacent two of the data signal lines 11 defining the G pixel are offset toward the pixel electrode 16 side of the G pixel with respect to the centers of the black matrix 302. In the example of FIG. 24, the data signal line 11 arranged between the R pixel and the G pixel is arranged to be offset toward the pixel electrode 16 side of the G pixel, and the data signal line 11 arranged between the G pixel and the B pixel is arranged to be offset toward the pixel electrode 16 side of the G pixel. The position of the data signal line 11 is not limited, but, for example, in FIG. 24, the data signal line 11 may be arranged at a position at which the center of the width W1 from one end of the sensor electrode line 12 to another end of the data signal line 11 substantially matches with the center of the black matrix 302.

With the above-mentioned configuration, the positions of the data signal line 11 and the sensor electrode line 12 are adjusted, and thus the balance between the display brightness and the color temperature can be adjusted.

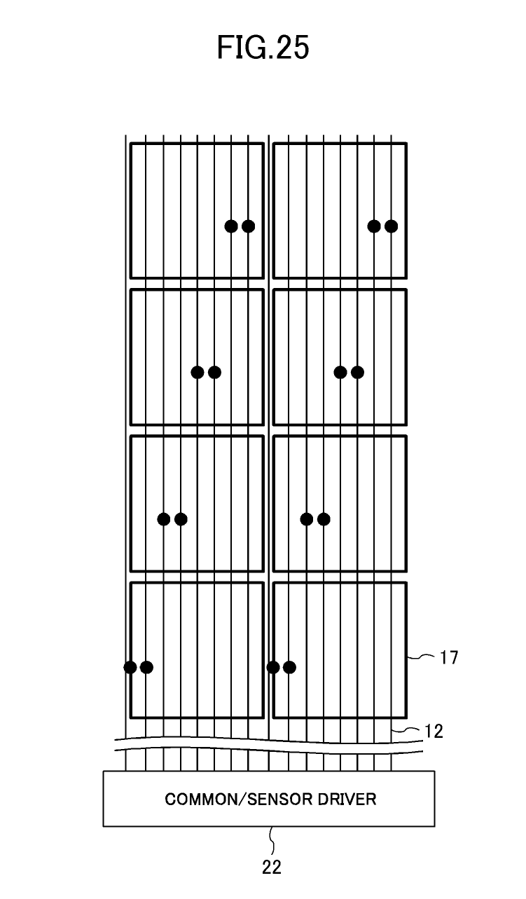

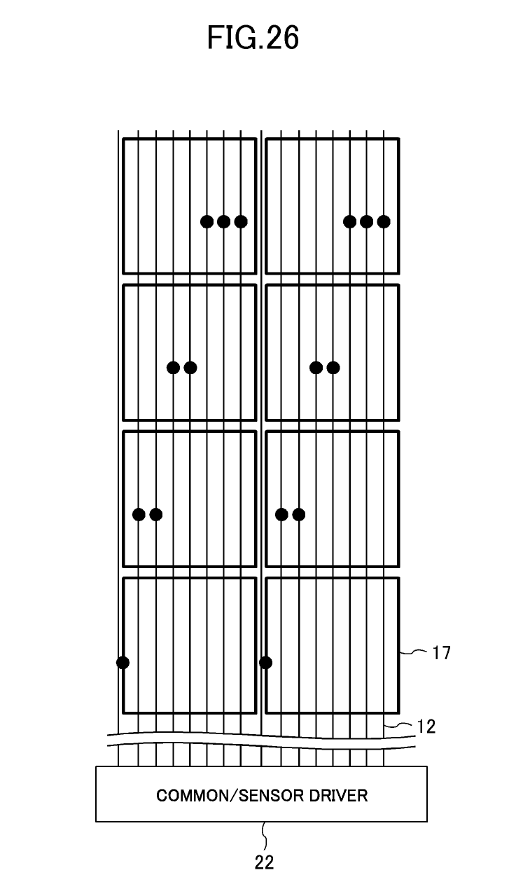

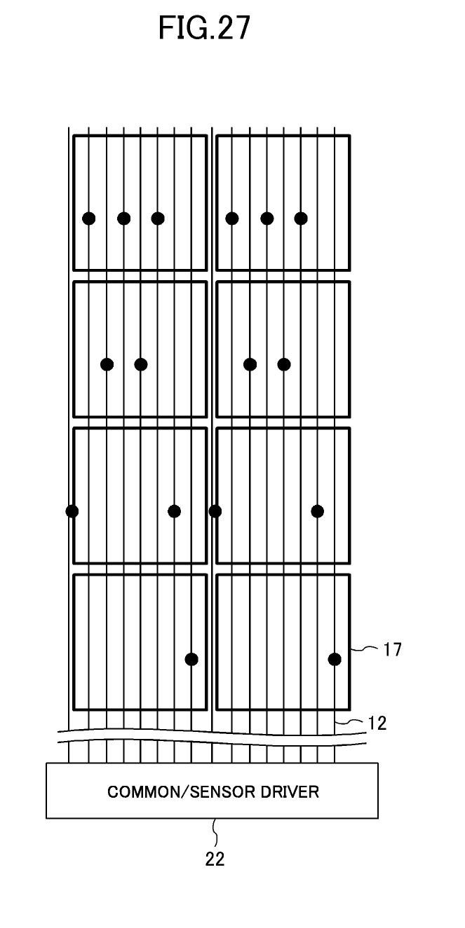

In the above-mentioned display panel 10 of each of the first to fourteenth embodiments, each common electrode 17 (sensor electrode) is electrically connected to a single sensor electrode line 12. However, the number of sensor electrode lines 12 to be electrically connected to the common electrode 17 is not limited. For example, each common electrode 17 (sensor electrode) may be electrically connected to two or more sensor electrode lines 12. FIGS. 25 to 27 are plan views illustrating configurations common to the display panels 10 of the first to fourteenth embodiments. In the configuration of FIG. 25, each common electrode 17 is electrically connected to two sensor electrode lines 12. Therefore, as compared to the case where each common electrode 17 is electrically connected to a single sensor electrode line 12, power feeding performance to each common electrode 17 can be improved. In the configuration of FIG. 26, the number of sensor electrode lines 12 to be electrically connected to the common electrode 17 arranged on a side closer to the common/sensor driver 22 is smaller than the number of sensor electrode lines 12 to be electrically connected to the common electrode 17 arranged on a side farther from the common/sensor driver 22. Therefore, the wiring resistance of the common electrode 17 closer to the common/sensor driver 22 can be equalized with the wiring resistance of the common electrode 17 farther from the common/sensor driver 22. In the configuration of FIG. 27, the connection points between the common electrode 17 and the sensor electrode lines 12 are arranged in a dispersed manner in a region in which the common electrode 17 is formed. Therefore, the voltage distribution in a single common electrode 17 can be equalized in plan view.

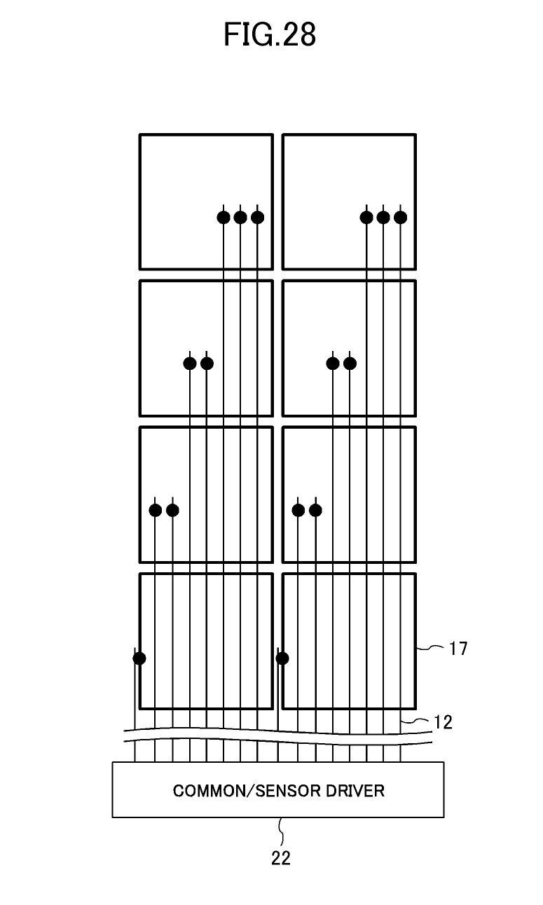

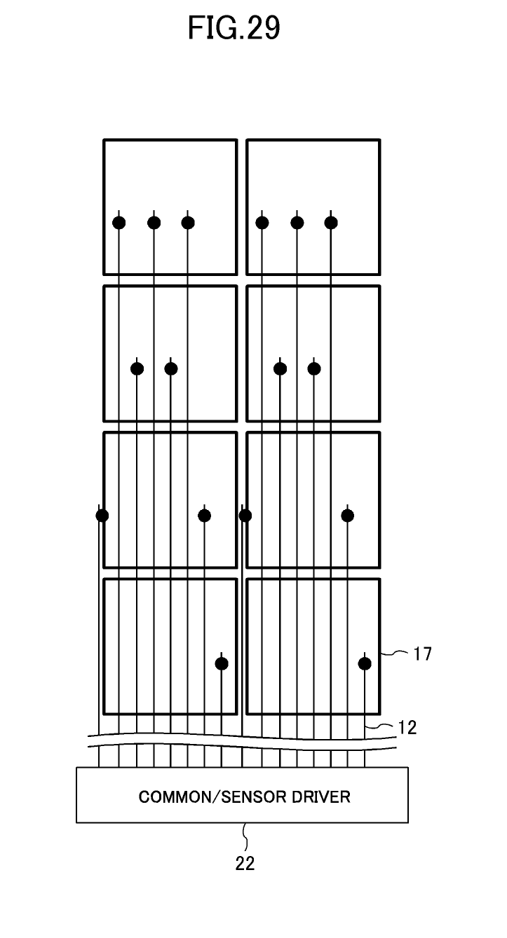

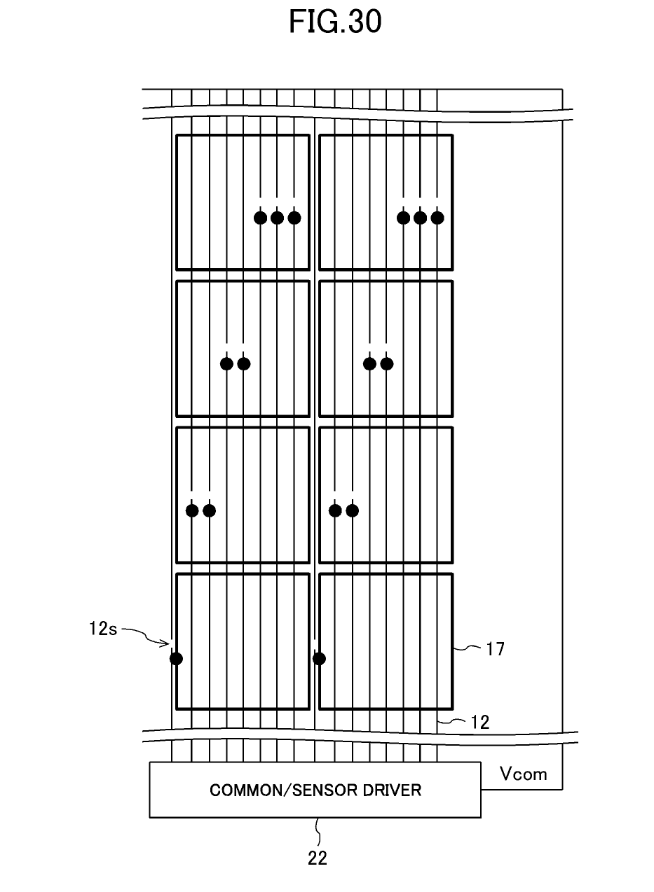

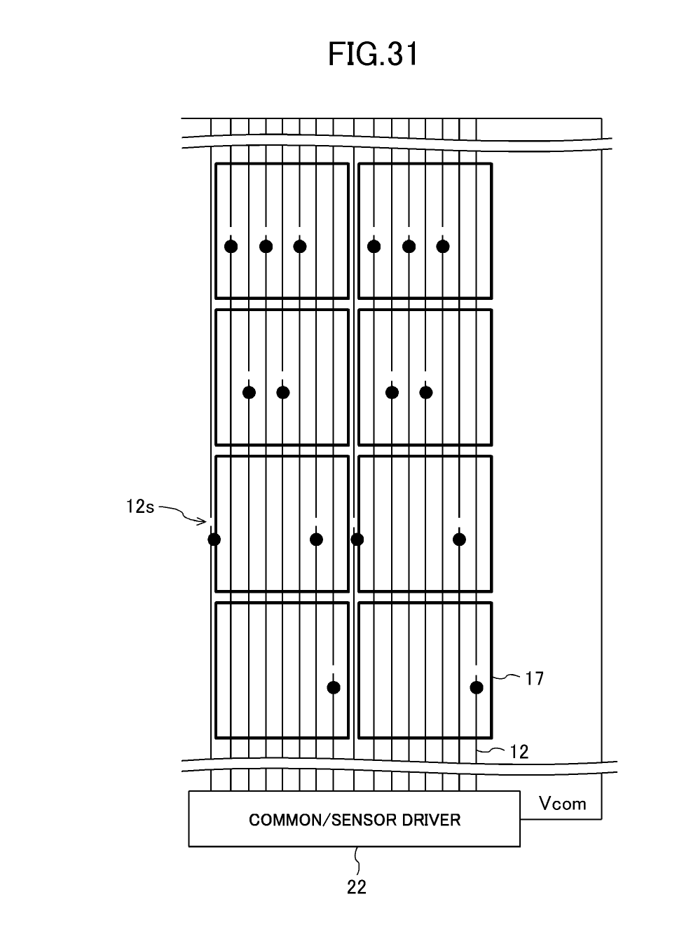

As illustrated in FIGS. 26 and 27, when the number of sensor electrode lines 12 to be electrically connected to a single common electrode 17 is increased in accordance with the distance from the common/sensor driver 22, the wiring resistance can be equalized among the respective common electrodes 17. Therefore, the length of the sensor electrode line 12 may differ in accordance with the place of the common electrode 17. Specifically, as illustrated in FIGS. 28 and 29, the length of the sensor electrode line 12 may be set to a length up to the connection point between the sensor electrode line 12 and the common electrode 17. Further, as illustrated in FIGS. 30 and 31, each sensor electrode line 12 may have a slit formed within a range from the connection point between the sensor electrode line 12 and the common electrode 17 to the terminal end of the sensor electrode line 12, so as to be electrically disconnected. Further, in the configurations illustrated in FIGS. 30 and 31, the terminal ends of the respective sensor electrode lines 12 may be connected to each other, and may be constantly supplied with a predetermined voltage (for example, Vcom). With this, the potential of the wiring in a floating state can be fixed. Further, with the configurations of FIGS. 25 to 31, the display quality and the accuracy of the detection function of the touch position can be improved.

While there have been described what are at present considered to be certain embodiments of the application, it will be understood that various modifications may be made thereto, and it is intended that the appended claims cover all such modifications as fall within the true spirit and scope of the invention.

What is claimed is:

1. A display panel, comprising:
a plurality of gate signal lines extending in a first direction;
a plurality of data signal lines and a plurality of sensor electrode lines, which extend in a second direction different from the first direction;
a plurality of pixel electrodes arranged so as to respectively correspond to a plurality of pixels arrayed in the first direction and the second direction, the plurality of pixel electrodes being divided into a plurality of groups; and
a plurality of common electrodes arranged at a ratio of one to a plurality of pixel electrodes included in one of the plurality of groups, wherein:
the plurality of sensor electrode lines are arranged in the same layer as the plurality of data signal lines;
at least two of the plurality of sensor electrode lines and each of the plurality of common electrodes overlap each other in plan view, and the each of the plurality of common electrodes is electrically connected to at least one of the at least two of the plurality of sensor electrode lines overlapping with the each of the plurality of common electrodes; and
at least one insulating film is formed between each of a region between the plurality of data signal lines and the plurality of sensor electrode lines, a region between the plurality of sensor electrode lines and the plurality of common electrodes, and a region between the plurality of common electrodes and the plurality of pixel electrodes.

2. The display panel according to claim 1, wherein each of the plurality of sensor electrode lines is arranged between adjacent two of the plurality of data signal lines in plan view.

3. The display panel according to claim 1, wherein each of the plurality of sensor electrode lines is arranged at a position with a substantially equal distance from each of adjacent two of the plurality of data signal lines in plan view.

4. The display panel according to claim 1, wherein the plurality of common electrodes are arrayed at equal intervals in the first direction and the second direction.

5. The display panel according to claim 1, wherein the each of the plurality of common electrodes is electrically connected to at least one of the plurality of sensor electrode lines via a through hole formed through the at least one insulating film formed in the region between the plurality of sensor electrode lines and the plurality of common electrodes.

6. The display panel according to claim 1, wherein:
the plurality of data signal lines and the plurality of sensor electrode lines are formed on a first insulating film formed so as to cover the plurality of gate signal lines;
a second insulating film is formed between the plurality of data signal lines and the plurality of sensor electrode lines so as to cover the plurality of data signal lines and the plurality of sensor electrode lines;
a third insulating film is formed on the second insulating film;
the plurality of common electrodes are formed on the third insulating film;
a fourth insulating film is formed between the plurality of common electrodes and the plurality of pixel electrodes so as to cover the plurality of common electrodes;
the plurality of pixel electrodes are formed on the fourth insulating film; and
the second insulating film and the third insulating film each have a through hole formed in a part thereof so as to electrically connect the each of the plurality of sensor electrode lines and corresponding one of the plurality of common electrodes to each other.

7. The display panel according to claim 1,
wherein the plurality of pixels comprise a red pixel for displaying red, a green pixel for displaying green, and a blue pixel for displaying blue, and
wherein each of the plurality of sensor electrode lines is arranged in the red pixel and the blue pixel, but is not arranged in the green pixel.

8. The display panel according to claim 1, wherein:
the plurality of data signal lines, the plurality of the sensor electrode lines, and the plurality of pixel electrodes are formed on a first insulating film formed so as to cover the plurality of gate signal lines;
a second insulating film is formed between the plurality of data signal lines and the plurality of sensor electrode lines so as to cover the plurality of data signal lines, the plurality of the sensor electrode lines, and the plurality of pixel electrodes;
the plurality of common electrodes are formed on the second insulating film; and
the second insulating film has a through hole formed in apart thereof so as to electrically connect the each of the plurality of sensor electrode lines and corresponding one of the plurality of common electrodes to each other.

9. The display panel according to claim 1, wherein the at least one insulating film is made of an organic material.

10. The display panel according to claim 1, further comprising shielding wiring arranged so as to cover a gap between adjacent two of the plurality of common electrodes in plan view.

11. The display panel according to claim 1, wherein the plurality of common electrodes are arranged so that a gap between adjacent two of the plurality of common electrodes overlaps with a gap between adjacent pixels in plan view.

12. The display panel according to claim 1, wherein the plurality of common electrodes are arranged so that a gap between adjacent two of the plurality of common electrodes is positioned close to a center of a pixel region in plan view.

13. The display panel according to claim 1, wherein a number of the sensor electrode lines to be electrically connected to corresponding one of the plurality of common electrodes, which is arranged on a side closer to a first drive circuit for outputting a sensor voltage, is smaller than a number of the sensor electrode lines to be electrically connected to corresponding one of the plurality of common electrodes, which is arranged on aside farther from the first drive circuit.
